(19) United States
(12) Patent Application Publication
(10) Pub. No.: US 2026/0218015 A1
(43) Pub. Date: Jul. 30, 2026

(54) SELF-ADHERED COVER TAPE FOR BUILDING APPLICATIONS AND RELATED SYSTEMS AND RELATED METHODS

(71) Applicant: BMIC LLC, Dallas, TX (US)

(72) Inventor: Lingtao Yu, Summit, NJ (US)

(21) Appl. No.: 19/461,003

(22) Filed: Jan. 27, 2026

Related U.S. Application Data
(60) Provisional application No. 63/749,958, filed on Jan. 27, 2025.

(51) Int. Cl. C09J 7/38; E04D 5/14

(52) U.S. Cl. CPC C09J 7/38; E04D 5/148; C09J 2203/346

(57) ABSTRACT

Self-adhered cover tapes are provided. A self-adhered cover tape comprises a first layer. The first layer has a first surface and a second surface opposite the first surface. The cover tape comprises a first adhesive strip located on the second surface of the first layer. The first adhesive strip covers 1% to 50% of the second surface. The first adhesive strip comprises a first pressure-sensitive adhesive having a first glass transition temperature. The cover tape comprises a second adhesive strip located on the second surface of the first layer and adjacent to the first adhesive strip. The second adhesive strip covers 1% to 50% of the second surface. The second adhesive strip comprises a second pressure-sensitive adhesive having a second glass transition temperature. The second glass transition temperature is at least 10 °F greater than the first glass transition temperature. Related systems and related methods are also provided.

### CROSS-REFERENCE TO RELATED APPLICATIONS

This application claims priority to U.S. Provisional Patent Application No. 63/749,958, filed January 27, 2025, and titled “SELF-ADHERED COVER TAPE FOR BUILDING APPLICATIONS AND RELATED SYSTEMS AND RELATED METHODS,” the entirety of which is herein incorporated by reference.

### FIELD

The present disclosure relates to a self-adhered cover tape for building applications, and related systems and related methods.

### BACKGROUND

Roofing accessories are installed in roofing systems, particularly on edge metal flashings, to prevent water penetration into an underlying building structure.

### SUMMARY

Some embodiments relate to a cover tape. In some embodiments, the cover tape comprises a first layer. In some embodiments, the first layer has a first surface and a second surface opposite the first surface. In some embodiments, the cover tape comprises a first adhesive strip. In some embodiments, the first adhesive strip is located on the second surface of the first layer. In some embodiments, the first adhesive strip comprises a first pressure-sensitive adhesive. In some embodiments, the first pressure-sensitive adhesive has a first glass transition temperature. In some embodiments, the cover tape comprises a second adhesive strip. In some embodiments, the second adhesive strip is located on the second surface of the first layer. In some embodiments, the second adhesive strip is adjacent to the first adhesive strip. In some embodiments, the second adhesive strip comprises a second pressure-sensitive adhesive. In some embodiments, the second pressure-sensitive adhesive has a second glass transition temperature. In some embodiments, the second glass transition temperature of the second pressure-sensitive adhesive is different from the first glass transition temperature of the first pressure-sensitive adhesive.

In some embodiments, the second glass transition temperature of the second pressure-sensitive adhesive is at least 10 °F greater than the first glass transition temperature of the first pressure-sensitive adhesive.

In some embodiments, the first adhesive strip covers 1% to 50% of the second surface of the first layer and the second adhesive strip covers 1% to 50% of the second surface of the first layer.

In some embodiments, the first pressure-sensitive adhesive comprises a 1% to 80% by weight of a first polymer based on a total weight of the first pressure-sensitive adhesive, 1% to 50% by weight of a first tackifier based on the total weight of the first pressure-sensitive adhesive, and 1% to 50% by weight of a first plasticizer based on the total weight of the first pressure-sensitive adhesive.

In some embodiments, the second pressure-sensitive adhesive comprises 1% to 80% by weight of a second polymer based on a total weight of the second pressure-sensitive adhesive, 1% to 50% by weight of a second tackifier based on the total weight of the second pressure-sensitive adhesive, and 1% to 50% by weight of a second plasticizer based on the total weight of the second pressure-sensitive adhesive.

In some embodiments, the cover tape further comprises a third adhesive strip. In some embodiments, the third adhesive strip is located on the second surface of the first layer. In some embodiments, the third adhesive strip is adjacent to the second adhesive strip opposite to the first adhesive strip. In some embodiments, the third adhesive strip comprises a third pressure-sensitive adhesive.

In some embodiments, the third pressure-sensitive adhesive is the same as the first pressure-sensitive adhesive.

In some embodiments, the cover tape further comprises a fourth adhesive strip. In some embodiments, the fourth adhesive strip is located on the second surface of the first layer. In some embodiments, the fourth adhesive strip is adjacent to the third adhesive strip opposite to the second adhesive strip. In some embodiments, the fourth adhesive strip comprises a fourth pressure-sensitive adhesive.

In some embodiments, the third pressure-sensitive adhesive is the same as the first pressure sensitive adhesive and the fourth pressure-sensitive adhesive is the same as the second pressure-sensitive adhesive.

In some embodiments, the second surface of the first layer has an adhesive portion. In some embodiments, the first adhesive strip covers 1% to 50% of the adhesive surface portion of the second surface. In some embodiments, the second adhesive strip covers 1% to 50% of the adhesive surface portion of the second surface. In some embodiments, the first adhesive strip and the second adhesive strip, in combination, cover 2% to 80% of the second surface of the first layer. In some embodiments, the second surface of the first layer has a heat-weldable surface portion. In some embodiments, the heat-weldable surface portion is adjacent to the adhesive surface portion. In some embodiments, the heat-weldable portion does not comprise an adhesive.

Some embodiments relate to a roofing system. In some embodiments, the roofing system comprises at least one roofing substrate. In some embodiments, roofing system comprises a cover tape. In some embodiments, the cover tape is located on the at least one roofing substrate. In some embodiments, the cover tape comprises a first layer. In some embodiments, the first layer has a first surface and a second surface opposite the first surface. In some embodiments, the cover tape comprises a first adhesive strip. In some embodiments, the first adhesive strip is located on the second surface of the first layer. In some embodiments, the first adhesive strip is adhered to the at least one roofing substrate. In some embodiments, the first adhesive strip comprises a first pressure-sensitive adhesive. In some embodiments, the first pressure-sensitive adhesive has a first glass transition temperature. In some embodiments, the cover tape comprises a second adhesive strip. In some embodiments, the second adhesive strip is located on the second surface of the first layer. In some embodiments, the second adhesive strip is adjacent to the first adhesive strip. In some embodiments, the second adhesive strip is adhered to the at least one roofing substrate. In some embodiments, the second adhesive strip comprises a second pressure-sensitive adhesive. In some embodiments, the second pressure-sensitive adhesive has a second glass transition temperature. In some embodiments, the second glass transition temperature of the second pressure-sensitive adhesive is different from the first glass transition temperature of the first pressure-sensitive adhesive.

In some embodiments, the at least one roofing substrate comprises a metal layer and a membrane. In some embodiments, the metal layer is located between the membrane and the cover tape, such that the first adhesive strip is adhered to the metal layer and the second adhesive strip is adhered to the membrane.

In some embodiments, the second glass transition temperature of the second pressure-sensitive adhesive is at least 10 °F greater than the first glass transition temperature of the first pressure-sensitive adhesive.

In some embodiments, the first adhesive strip covers 1% to 50% of the second surface of the first layer and the second adhesive strip covers 1% to 50% of the second surface of the first layer.

In some embodiments, the first pressure-sensitive adhesive comprises a 1% to 80% by weight of a first polymer based on a total weight of the first pressure-sensitive adhesive, 1% to 50% by weight of a first tackifier based on the total weight of the first pressure-sensitive adhesive, and 1% to 50% by weight of a first plasticizer based on the total weight of the first pressure-sensitive adhesive.

In some embodiments, the second pressure-sensitive adhesive comprises 1% to 80% by weight of a second polymer based on a total weight of the second pressure-sensitive adhesive, 1% to 50% by weight of a second tackifier based on the total weight of the second pressure-sensitive adhesive, and 1% to 50% by weight of a second plasticizer based on the total weight of the second pressure-sensitive adhesive.

In some embodiments, the cover tape further comprises a third adhesive strip. In some embodiments, the third adhesive strip is located on the second surface of the first layer. In some embodiments, the third adhesive strip is adjacent to the second adhesive strip. In some embodiments, the third adhesive strip comprises a third pressure-sensitive adhesive.

In some embodiments, the third pressure-sensitive adhesive is the same as the first pressure-sensitive adhesive.

In some embodiments, the cover tape further comprises a fourth adhesive strip. In some embodiments, the fourth adhesive strip is located on the second surface of the first layer. In some embodiments, the fourth adhesive strip is adjacent to the third adhesive strip. In some embodiments, the fourth adhesive strip comprises a third pressure-sensitive adhesive.

In some embodiments, the second surface of the first layer has an adhesive portion. In some embodiments, the first adhesive strip covers 1% to 50% of the adhesive surface portion of the second surface. In some embodiments, the second adhesive strip covers 1% to 50% of the adhesive surface portion of the second surface. In some embodiments, the first adhesive strip and the second adhesive strip, in combination, cover 2% to 80% of the second surface of the first layer. In some embodiments, the second surface of the first layer has a heat-weldable surface portion. In some embodiments, the heat-weldable surface portion is adjacent to the adhesive surface portion. In some embodiments, the heat-weldable portion does not comprise an adhesive.

### BRIEF DESCRIPTION OF THE DRAWINGS

Reference is made to the drawings that form a part of this disclosure, and which illustrate embodiments in which the materials and methods described herein can be practiced.

FIG. 1 is a schematic diagram of a cross-section of a self-adhered cover tape, according to some embodiments.

FIG. 2 is a schematic diagram of a cross-section of a self-adhered cover tape, according to some embodiments.

FIG. 3 is a schematic diagram of a cross-section of a self-adhered cover tape, according to some embodiments.

FIG. 4 is a schematic diagram of a cross-section of a self-adhered cover tape, according to some embodiments.

FIG. 5 is a schematic diagram of a cross-section of a roofing system, according to some embodiments.

FIG. 6 is a flowchart of a method of installation, according to some embodiments.

### DETAILED DESCRIPTION

Some embodiments relate to a cover tape for building applications, such as, for example and without limitation, roofing applications, among other things. In some embodiments, the cover tape for building applications can be installed on building materials, such as, for example and without limitation, structural panels, structural supports, structural beams, exterior and/or interior wall panels, flooring materials, roofing materials, or any combination thereof. In some embodiments, roofing materials comprise at least one of an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a building structure, a high density cover board, a cement board, concrete, a base sheet, a pipe, a chimney, a wax paper, a roof shingle, a mat, a fabric, a glass mat, a fiberglass mat, a woven mat, a nonwoven mat, a fabric, a polyester mat, a scrim, a coated scrim, a metal, or any combination thereof.

In some embodiments, by combining two or more pressure-sensitive adhesive strips with different glass transition temperatures, the cover tape can achieve complementary coverage and extend the performing temperature range versus conventional cover tapes that only have one pressure-sensitive adhesive.

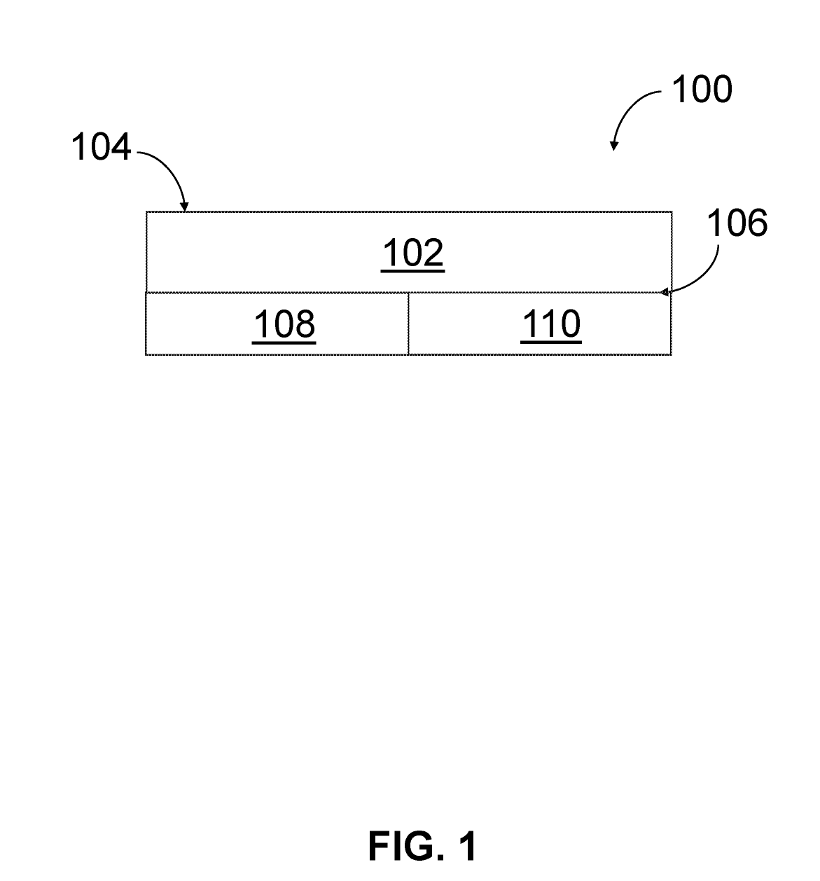

FIG. 1 is a schematic diagram of a cross-section of a self-adhered cover tape 100, according to some embodiments. As shown in FIG. 1, the cover tape 100 comprises a first layer 102. In some embodiments, the first layer 102 has a first surface 104 and a second surface 106. In some embodiments, the cover tape 100 comprises a first adhesive strip 108. In some embodiments, the first adhesive strip 108 is located on the second surface 106 of the first layer 102. In some embodiments, the cover tape 100 comprises a second adhesive strip 110. In some embodiments, the second adhesive strip 110 is located on the second surface 106 of the first layer 102. In some embodiments, the second adhesive strip 110 is adjacent to the first adhesive strip 108.

In some embodiments, the first layer 102 comprises at least one of a paper, a polymer, a textile, a metallic foil, or any combination thereof. In some embodiments, the first layer 102 comprises a polymer. In some embodiments, the polymer comprises at least one of a crosslinkable polymer, a crosslinked polymer, a non-crosslinked polymer, or any combination thereof. In some embodiments, the polymer comprises at least one of a thermoplastic polyolefin (TPO), a polyvinyl chloride (PVC), an ethylene propylene diene monomer (EPDM), a polysiloxane, a silyl-terminated polymer (STP), or any combination thereof. In some embodiments, the polymer comprises at least one of a linear polysiloxane, a cyclic polysiloxane, a branched polysiloxane, a silyl-terminated polyurethane, a silyl-terminated polyether, a silyl-terminated acrylic, a silyl-terminated polyester, polyester, polyethylene, polypropylene, polyurethane, polyurea, or any combination thereof. In some embodiments, the at least one polymer comprises at least one of a liquid silicone resin, a liquid silicone rubber resin (LSR), a heat cured, a silicone resinsilicone gum, or any combination thereof. In some embodiments, the at least one polymer comprises at least one of a linear polysiloxane, a cyclic polysiloxane, a branched polysiloxane, polyester, polyethylene, polypropylene, polyurethane, polyurea, a liquid silicone resin, a liquid silicone rubber resin (LSR), a heat cured silicone resin, a silicone gum, a polyolefin, a polycarbonate, a polyether, a silyl-terminated polyurethane, a silyl-terminated polyether, a silyl-terminated acrylic, a silyl-terminated polyester, or any combination thereof.

In some embodiments, the first layer 102 comprises a textile. In some embodiments, the textile comprises at least one of a mesh, a fabric, a fleece, a mat, a scrim, a scrim, a coated scrim, a woven, a non-woven, or any combination thereof. In some embodiments, the textile comprises a fibrous material. In some embodiments, the fibrous material comprises at least one of a natural fiber, a synthetic fiber, or any combination thereof. In some embodiments, the textile comprises at least one of a polyolefin (e.g., at least one of a polyethylene, a polypropylene, any copolymer thereof, any blend thereof, or any combination thereof), a polyester, a polyamide, a glass, a fiberglass, or any combination thereof.

In some embodiments, the first layer 102 comprises a metallic foil. In some embodiments, the metallic foil comprises at least one of an aluminum, a copper, a magnesium, a zinc, a nickel, a tin, a gold, a silver, alloys thereof, or any combination thereof.

In some embodiments, the cover tape comprises a first adhesive strip 108. In some embodiments, the first adhesive strip 108 is located on the second surface 106 of the first layer 102. In some embodiments, the first adhesive strip 108 covers 1% to 50%, or any range of subrange of 1% to 50%, of the second surface 106 of the first layer 102. In some embodiments, the first adhesive strip 108 covers 1% to 45%, 1% to 40%, 1% to 35%, 1% to 30%, 1% to 25%, 1% to 20%, 1% to 15%, 1% to 10%, 1% to 5%, 5% to 50%, 10% to 50%, 15% to 50%, 20% to 50%, 25% to 50%, 30% to 50%, 35% to 50%, 40% to 50%, or 45% to 50% of the second surface 106 of the first layer 102.

In some embodiments, the first adhesive strip 108 comprises a first pressure-sensitive adhesive. In some embodiments, a pressure-sensitive adhesive comprises an adhesive that forms a bond when pressure is applied to the adhesive with a surface. In some embodiments, the first adhesive strip 108 does not comprise a heat activated adhesive. In some embodiments, the first adhesive strip 108 does not comprise a thermally activated adhesive. In some embodiments, the first pressure-sensitive adhesive is a water-dispersed adhesive, a solvent dispersed adhesive, a sprayable adhesive, or any combination thereof. In some embodiments, when the first adhesive strip 108 is applied to the second surface 106 of the first layer 102, the first adhesive strip may be applied using at least one of a static charge, a roller, a brush, a sprayer, a knife, an adhesive spreader, an extruder, or any combination thereof.

In some embodiments, the first pressure-sensitive adhesive comprises a first polymer. In some embodiments, the first polymer comprises at least one of an elastomer, a polyolefin, a resin, a thermoset, a thermoplastic, or any combination thereof. In some embodiments, the polymer comprises at least one of a thermosetting polyolefin, thermoplastic polyolefin (TPO), a silyl-modified polymer, a silane-terminated polymer, a natural rubber, a poly-alpha-olefin (APAO/APO) polymer, a polyamide polyvinyl acetate, a polyvinyl alcohol, a polyamide, a polyester, a polyester amide, a polyvinyl butyrate, a polysiloxane or a silicone, a polychloroprene, a polycarbonate, a polyurethane, an asphalt, a butyl, an epoxy, a rubber, a butyl rubber, a polyisoprene, a polystyrene, a styrenic copolymer (e.g,. a styrenic block copolymer), a styrene-butadiene-styrene (SBS), a styrene-isoprene-styrene (SIS), a styrene butadiene (SB), a styrene-ethylene-butadiene-styrene (SEBS), an ethylene vinyl acetate (EVA), a polyvinyl acetate, an acrylic, a vinyl acetate acrylic, an ethylene vinyl acetate, an ethylene acrylic, a styrene acrylic, a vinyl chloride acrylic, a vinyl versatate, any copolymer thereof, or any combination thereof. In some embodiments, the first pressure-sensitive adhesive does not comprise any one or more of the first polymers disclosed herein.

In some embodiments, the first polymer comprises at least one of an acrylic, a silicone, a polyisoprene, a styrenic block copolymer, or any combination thereof. In some embodiments, the first polymer comprises an acrylic have a glass transition temperature of -80 °F to -40 °F, for example, -80, -75, -70, -65, -60, -55, -50, -45, or -40 °F, including ranges between any of the foregoing values. In some embodiments, the first polymer comprises a silicone having a glass transition temperature of -185 °F to -80 °F, for example, -185, -180, -170, -160, -150, -140, -130, -120, -110, -100, -90, or -80 °F, including ranges between any of the foregoing values. In some embodiments, the first polymer includes a polyisoprene having a glass transition temperature of -100 °F to -80 °F, for example, -100, -95, -90, -85, or -80 °F, including ranges between any of the foregoing values. In some embodiments, the first polymer comprises a styrenic block copolymer having a glass transition temperature of -130 °F to -30 °F, for example, -130, -120, -110, -100, -90, -80, -70, -60, -50, -40, or -30 °F, including ranges between any of the foregoing values. In some embodiments, the glass transition temperature is measured using Dynamic Mechanical Analysis (DMA).

In some embodiments, the first polymer only comprises one type of polymer. In some embodiments, the first polymer comprises more than one type of polymer. In some embodiments, the first polymer only comprises one polymer. In some embodiments, the first polymer comprises more than one polymer.

In some embodiments, the first pressure-sensitive adhesive comprises 0.5% to 80%, or any range or subrange between 0.5% to 80%, by weight of the first polymer based on a total weight of the first pressure-sensitive adhesive. In some embodiments, the first pressure sensitive adhesive comprises 0.5% to 75%, 0.5% to 70%, 0.5% to 65%, 0.5% to 60%, 0.5% to 55%, 0.5% to 50%, 0.5% to 45%, 0.5% to 40%, 0.5% to 35%, 0.5% to 30%, 0.5% to 25%, 0.5% to 20%, 0.5% to 15%, 0.5% to 10%, 0.5% to 5%, or 0.5% to 1% by weight of the first based on a total weight of the first pressure-sensitive adhesive. In some embodiments, the first pressure-sensitive adhesive comprises 1% to 80%, 5% to 80%, 10% to 80%, 15% to 80%, 20% to 80%, 25% to 80%, 30% to 80%, 35% to 80%, 40% to 80%, 45% to 80%, 50% to 80%, 55% to 80%, 60% to 80%, 65% to 80%, 70% to 80%, or 75% to 80% by weight of the first polymer based on a total weight of the first pressure-sensitive adhesive.

In some embodiments, the first pressure-sensitive adhesive comprises a first tackifier. In some embodiments, the first tackifier comprises at least one of a liquid rubber, a hydrocarbon resin such as a C5 aliphatic resin, a C9 aromatic resin, or a C5/C9 copolymer resin; a rosin-based resin such as a rosin, a polymerized rosin, a hydrogenated rosin, or a rosin ester; a terpene resin such as a terpene phenol resin, an aromatic-modified terpene resin, a hydrogenated terpene resin, or a polyterpene resin; a phenolic resin such as a phenol formaldehyde resin, a bisphenol A resin, a novolac resin, or a resorcinol formaldehyde resin; or any combination thereof. In some embodiments, the first pressure-sensitive adhesive does not comprise any one or more of the first tackifiers disclosed herein.

In some embodiments, the first pressure-sensitive adhesive comprises 0.1% to 50%, or any range or subrange between 0.1% to 50%, by weight of a first tackifier based on a total weight of the first pressure-sensitive adhesive. In some embodiments, the first pressure-sensitive adhesive comprises 0.1% to 45%, 0.1% to 40%, 0.1% to 35%, 0.1% to 30%, 0.1% to 25%, 0.1% to 20%, 0.1% to 15%, 0.1% to 10%, 0.1% to 5%, 0.1% to 1%, or 0.1% to 0.5% of a first tackifier based on a total weight of the first pressure-sensitive adhesive. In some embodiments, the first pressure-sensitive adhesive comprises 0.5% to 50%, 1% to 50%, 5% to 50%, 10% to 50%, 15% to 50%, 20% to 50%, 25% to 50%, 30% to 50%, 35% to 50%, 40% to 50%, or 45% to 50% by weight of a first tackifier based on a total weight of the first pressure-sensitive adhesive. In some embodiments, the first pressure-sensitive adhesive does not comprise a tackifier.

In some embodiments, the first pressure-sensitive adhesive comprises a first plasticizer. In some embodiments, the first plasticizer comprises at least one of a phthalate ester such as a dioctyl phthalate (DOP), a dibutyl phtalate (DBP), a di-isononyl phtalate (DINP), a di-isodecyl phtalate (DIDP), or a butylbenzyl phtalate (BBP); an aliphatic dibasic ester such as a dioctyl adipate, a dioctyl sebacate, a dibutyl sebacate, or an isodecyl succinate; a fatty acid ester such as a butyl oleate or an acetylricinoleic acid methyl ester; a polyalkylene glycol ester such as a diethylene glycol dibenzoate, a triethylene glycol dibenzoate, or a pentaerythritol ester; a phosphate such as a tricresyl phosphate or a tributyl phosphate; a trimellitate; a polystyrene or a poly-α-methylstyrene; a hydrocarbon polymer such as a polybutadiene, a polybutene, a polyisobutylene, a poly-(butadieneacrylonitrile), or a polychloroprene; a paraffinic oil; a naphthenic oil; a process oil; a polyether polyol such as a polyethylene glycol, a polypropylene glycol, or polytetramethylene glycol; a polyether substituting ester or ether group for the hydroxyl group of the polyether polyol; an epoxidized plasticizer such as an epoxidized soybean oil or an epoxidized benzyl stearate; a polyester plasticizer which are obtained by esterifying a dibasic acid such as a sebacic acid, an adipic acid, an azelaic acid, or a phthalic acid and a dihydric alcohol such as an ethylene glycol, a diethylene glycol, a triethylene glycol, a propylene glycol, or a dipropylene glycol; or any combination thereof. In some embodiments, the first pressure-sensitive adhesive does not comprise any one or more of the first plasticizers disclosed herein.

In some embodiments, the first pressure-sensitive adhesive comprises 0.1% to 50%, or any range or subrange between 0.1% to 50%, by weight of a first plasticizer based on a total weight of the first pressure-sensitive adhesive. In some embodiments, the first pressure-sensitive adhesive comprises 0.1% to 45%, 0.1% to 40%, 0.1% to 35%, 0.1% to 30%, 0.1% to 25%, 0.1% to 20%, 0.1% to 15%, 0.1% to 10%, 0.1% to 5%, 0.1% to 1%, or 0.1% to 0.5% of a first plasticizer based on a total weight of the first pressure-sensitive adhesive. In some embodiments, the first pressure-sensitive adhesive comprises 0.5% to 50%, 1% to 50%, 5% to 50%, 10% to 50%, 15% to 50%, 20% to 50%, 25% to 50%, 30% to 50%, 35% to 50%, 40% to 50%, or 45% to 50% by weight of a first plasticizer based on a total weight of the first pressure-sensitive adhesive.

In some embodiments, the first pressure-sensitive adhesive comprises an additive. In some embodiments, the additive comprises at least one of a crosslinker, a catalyst, an adhesion promoter, a fire retardant, a filler, an antioxidant, a pigment, a colorant, a dye, a binding agent, an antistatic agent, a stabilizer, a UV stabilizer, an anti-blocking agent, a UV absorber, a surfactant, a wax, or any combination thereof. In some embodiments, the additive is different from the tackifier. In some embodiments, the additive is different from the plasticizer. In some embodiments, the first pressure-sensitive adhesive does not comprise any one or more of the additives disclosed herein.

In some embodiments, the additive comprises a crosslinker. In some embodiments, the crosslinker comprises a neutral curing agent. In some embodiments, the crosslinker comprises at least one of ketoxime silanes, alkoxysilanes, acetoxysilanes, isopropenoxy silanes, a partial hydrolysate/condensate of said silanes, or any combination thereof. In some embodiments, the crosslinker comprises an organosilane, which may contain at least 2 or at least 3 hydrolyzable groups in one molecule and/or its partial hydrolysate. In some embodiments, a hydrolyzable group in such an organosilane or its partial hydrolysate includes at least one of a ketoxime group, an alkoxy group, an acetoxy group, an isopropenoxy group, or any combination thereof. In some embodiments, the crosslinker comprises an organic titanate, a thermal radical initiator, a UV radical initiator, or any combination thereof. In some embodiments, the crosslinker comprises ketoxime silanes. In some embodiments, a ketoxime silane comprises at least one of tetrakis(methylethylketoxime)silane, methyltris(dimethylketoxime)silane, methyltris(methylethylketoxime)silane, ethyltris(methylethylketoxime)silane, methyltris(methyl isobutyl ketoxime)silane, vinyl tris(methylethylketoxime)silane or any combination thereof. In some embodiments, the crosslinker comprises an alkoxysilane. In some embodiments, the alkoxysilane comprises at least one of methyltrimethoxysilane, vinyltrimethoxysilane, phenyltrimethoxysilane, vinyltriethoxy silane, or any combination thereof. In some embodiments, the crosslinker comprises an acetoxysilane. In some embodiments, the acetoxysilane comprises at least one of methyltriacetoxysilane, vinyltriacetoxysilane, or any combination thereof. In some embodiments, the crosslinker comprises an isopropenoxy silane. In some embodiments, the isopropenoxy silane comprises at least one of methyltriisopropenoxysilane, vinyltriisopropenoxysilane, phenyltriisopropenoxysilane, or any combination thereof. In some embodiments, the crosslinker comprises a partial hydrolysate/condensate of any one of the silanes disclosed herein. In some embodiments, the crosslinker comprises at least one of methyltris(methylethylketoxime)silane, vinyltris(methylethylketoxime)silane, or any combination thereof. In some embodiments, the first pressure-sensitive adhesive does not comprise any one or more of the crosslinkers disclosed herein.

In some embodiments, the additive comprises a catalyst. In some embodiments, the catalyst comprises at least one of an organic tin, an organic platinum, triethanolamine titanate, dimethyltin dioleate, dibutyltin diacetate, stannous octoate, dibutyltin dioctoate, dibutyltin dilaurate, dibutyltin dimethoxide, dibutyltin bis(acetylacetonate), dibutyltin bis(benzylmalate), dimethyltin dimethoxide, dimethyltin diacetate, dioctyltin dioctate, dioctyltin dilaurate, tin dioctate, tin laurate, tetraisopropyl titanate, tetra-n-butyl titanate, tetra-tertiary butyl titanate, tetra-n-propyl titanate, tetra-2-ethylhexyl titanate, diisopropyl di-tertiary butyl titanate, dimethoxy titanium bisacetylacetonate, diisopropoxy titanium bisethyl acetoacetate, di-tertiary butoxy titanium bisethyl acetoacetate, di-tertiary butoxy titanium bismethyl acetoacetate, or any combination thereof. In some embodiments, the first pressure-sensitive adhesive does not comprise any one or more of the catalysts disclosed herein.

In some embodiments, the additive comprises an adhesion promoter. In some embodiments, the adhesion promoter comprises at least one of dichlorodimethyl silane, a chlorinated polyolefin, an organosilane, an organotitanate, a zircoaluminate, a zirconate, an acrylate, an aryl phosphate ester, an alkyl phosphate ester, an aryl alkyl phosphate ester, a metal organic, a silica, a fumed silica, N-(2-aminoethyl)-3-aminopropyltrimethoxysilane, vinyl tris(2-methoxyethoxy)silane, 3-methacryloxypropyltrimethoxysilane, 2-(3,4-epoxycyclohexyl)ethyl trimethoxysilane, 3-glycidoxypropyltrimethoxysilane, 3-glycidoxypropylmethyldiethoxysilane, N-(2-aminoethyl)3-aminopropyltrimethoxysilane, 3-aminopropyltriethoxysilane, 3-(N-aminomethylbenzylamino)propyltrimethoxysilane, 3-mercaptopropyltrimethoxysilane, 3-aminopropyltris(methylethylketoxime)silane, 3-glycidoxy propyltriisopropenoxysilane, 3-glycidoxypropylmethyldiisopropenoxysilane, any reaction product thereof, or any combination thereof. In some embodiments, the adhesion promoter is a reaction product of dichlorodimethylsilane and a silica agent. In some embodiments, the silica agent comprises a fumed silica. In some embodiments, the adhesion promoter comprises at least one of tetraethyl orthosilicate, aminopropyltrimethoxysilane, or any combination thereof. In some embodiments, the first pressure-sensitive adhesive does not comprise any one or more of the adhesion promoters disclosed herein.

In some embodiments, the additive comprises a filler. In some embodiments, the filler comprises at least one of nepheline syenite, magnesium oxide, zinc oxide, calcium carbonate, barium sulfate, iron oxide, diatomaceous earth, melamine, quartz, silica, colloidal silica, crystalline silica, precipitated silica, amorphous silica, titanium dioxide, alumina trihydrate, zinc oxide, zirconium oxide, zirconium silicate, zinc borate, chromic oxide, crystalline silica fine powder, amorphous silica fine powder, silicone rubber powder, glass, glass bubbles, glass powder, zeolites, silica hydrogen, silica aero gel, calcium silicate, aluminum silicate, aluminum oxide, ferrite, carbon black, graphite, mica, clay, bentonite, ground quartz, kaolin, calcined kaolin, wollastonite, hydroxyapatite, hydrated alumina, magnesium hydroxide, vermiculite, talcum, slaked lime, or any combination thereof. In some embodiments, the first pressure-sensitive adhesive does not comprise any one or more of the fillers disclosed herein.

In some embodiments, the first pressure-sensitive adhesive comprises 0.1% to 50%, or any range or subrange between 0.1% to 50%, by weight of an additive based on a total weight of the first pressure-sensitive adhesive. In some embodiments, the first pressure-sensitive adhesive comprises 0.1% to 45%, 0.1% to 40%, 0.1% to 35%, 0.1% to 30%, 0.1% to 25%, 0.1% to 20%, 0.1% to 15%, 0.1% to 10%, 0.1% to 5%, 0.1% to 1%, or 0.1% to 0.5% of an additive based on a total weight of the first pressure-sensitive adhesive. In some embodiments, the first pressure-sensitive adhesive comprises 0.5% to 50%, 1% to 50%, 5% to 50%, 10% to 50%, 15% to 50%, 20% to 50%, 25% to 50%, 30% to 50%, 35% to 50%, 40% to 50%, or 45% to 50% by weight of an additive based on a total weight of the first pressure-sensitive adhesive.

In some embodiments, the first pressure-sensitive adhesive has a first glass transition temperature. In some embodiments, the first glass transition temperature is less than 0 °F. In some embodiments, the first glass transition temperature is less than -5 °F, less than -10 °F, less than -15 °F, less than -20 °F, less than -25 °F, less than -30 °F, less than -35 °F, less than -40 °F, less than -45 °F, less than -50 °F, less than -55 °F, less than -60 °F, less than -65 °F, less than -70 °F, less than -75 °F, less than -80 °F, less than -85 °F, less than -90 °F, less than -95 °F, less than -100 °F, less than -105 °F, less than -110 °F, less than -115 °F, or less than -120 °F. In some embodiments, the glass transition temperature is measured using Dynamic Mechanical Analysis (DMA).

In some embodiments, the first glass transition temperature is -120 °F to 0 °F, or any range or subrange between -120 °F to 0 °F. In some embodiments, the first glass transition temperature is -120 °F to -5 °F, -120 °F to -10 °F, -120 °F to -15 °F, -120 °F to -20 °F, -120 °F to -25 °F, -120 °F to -30 °F, -120 °F to -35 °F, -120 °F to -40 °F, -120 °F to -45 °F, -120 °F to -50 °F, -120 °F to -55 °F, -120 °F to -60 °F, -120 °F to -65 °F, -120 °F to -70 °F, -120 °F to -75 °F, -120 °F to -80 °F, -120 °F to -85 °F, -120 °F to -90 °F, -120 °F to -95 °F, -120 °F to -100 °F, -120 °F to -105 °F, -120 °F to -110 °F, or -120 °F to -115 °F. In some embodiments, the first glass transition temperature is -115 °F to 0 °F, -110 °F to 0 °F, -105 °F to 0 °F, -100 °F to 0 °F, -95 °F to 0 °F, -90 °F to 0 °F, -85 °F to 0 °F, -80 °F to 0 °F, -75 °F to 0 °F, -70 °F to 0 °F, -65 °F to 0 °F, -60 °F to 0 °F, -55 °F to 0 °F, -50 °F to 0 °F, -45 °F to 0 °F, -40 °F to 0 °F, -35 °F to 0 °F, -30 °F to 0 °F, -25 °F to 0 °F, -20 °F to 0 °F, -15 °F to 0 °F, -10 °F to 0 °F, or -5 °F to 0 °F. In some embodiments, the glass transition temperature is measured using Dynamic Mechanical Analysis (DMA).

In some embodiments, the cover tape comprises a second adhesive strip 110. In some embodiments, the second adhesive strip 110 is located on the second surface 106 of the first layer 102. In some embodiments, the second adhesive strip 110 is adjacent to the first adhesive strip 108. In some embodiments, the second adhesive strip 110 covers 1% to 50%, or any range of subrange of 1% to 50%, of the second surface 106 of the first layer 102. In some embodiments, the second adhesive strip 110 covers 1% to 45%, 1% to 40%, 1% to 35%, 1% to 30%, 1% to 25%, 1% to 20%, 1% to 15%, 1% to 10%, 1% to 5%, 5% to 50%, 10% to 50%, 15% to 50%, 20% to 50%, 25% to 50%, 30% to 50%, 35% to 50%, 40% to 50%, or 45% to 50% of the second surface 106 of the first layer 102.

In some embodiments, the second adhesive strip 110 comprises a second pressure-sensitive adhesive. A pressure-sensitive adhesive is an adhesive that forms a bond when pressure is applied to the adhesive with a surface. In some embodiments, the second adhesive strip 110 does not comprise a heat activated adhesive. In some embodiments, the second adhesive strip 110 does not comprise a thermally activated adhesive. In some embodiments, the second pressure-sensitive adhesive is a water-dispersed adhesive, a solvent dispersed adhesive, a sprayable adhesive, or any combination thereof. In some embodiments, when the second adhesive strip 110 is applied to the second surface 106 of the first layer 102, the first adhesive strip may be applied using a static charge, a roller, a brush, a sprayer, a knife, an adhesive spreader, an extruder, or any other known technique. In some embodiments, the second adhesive strip 110 is applied at the same time the first adhesive strip 108 is applied. In some embodiments, the second adhesive strip 110 is applied after the first adhesive strip 108 is applied. In some embodiments, the second adhesive strip 110 is applied before the first adhesive strip 108.

In some embodiments, the second pressure-sensitive adhesive comprises a second polymer. In some embodiments, the second polymer comprises at least one of an elastomer, a polyolefin, a resin, a thermoset, a thermoplastic, or any combination thereof. In some embodiments, the polymer comprises at least one of a thermosetting polyolefin, thermoplastic polyolefin (TPO), a silyl-modified polymer, a silane-terminated polymer, a natural rubber, a poly-alpha-olefin (APAO/APO) polymer, a polyamide polyvinyl acetate, a polyvinyl alcohol, a polyamide, a polyester, a polyester amide, a polyvinyl butyrate, a polysiloxane or a silicone, a polychloroprene, a polycarbonate, a polyurethane, an asphalt, a butyl, an epoxy, a rubber, a butyl rubber, a polyisoprene, a polystyrene, a styrenic copolymer (e.g,. a styrenic block copolymer), a styrene-butadiene-styrene (SBS), a styrene-isoprene-styrene (SIS), a styrene butadiene (SB), a styrene-ethylene-butadiene-styrene (SEBS), an ethylene vinyl acetate (EVA), a polyvinyl acetate, an acrylic, a vinyl acetate acrylic, an ethylene vinyl acetate, an ethylene acrylic, a styrene acrylic, a vinyl chloride acrylic, a vinyl versatate, any copolymer thereof, or any combination thereof. In some embodiments, the second pressure-sensitive adhesive does not comprise any one or more of the second polymers disclosed herein. In some embodiments, the second polymer of the second pressure-sensitive adhesive is the same as the first polymer of the first pressure-sensitive adhesive. In some embodiments, the second polymer of the second pressure-sensitive adhesive is different from the first polymer of the first pressure-sensitive adhesive.

In some embodiments, the second polymer comprises at least one of an acrylic, a silicone, a polyisoprene, a styrenic block copolymer, or any combination thereof. In some embodiments, the second polymer comprises an acrylic have a glass transition temperature of -80 °F to -40 °F, for example, -80, -75, -70, -65, -60, -55, -50, -45, or -40 °F, including ranges between any of the foregoing values. In some embodiments, the second polymer comprises a silicone having a glass transition temperature of -185 °F to -80 °F, for example, -185, -180, -170, -160, -150, -140, -130, -120, -110, -100, -90, or -80 °F, including ranges between any of the foregoing values. In some embodiments, the second polymer includes a polyisoprene having a glass transition temperature of -100 °F to -80 °F, for example, -100, -95, -90, -85, or -80 °F, including ranges between any of the foregoing values. In some embodiments, the second polymer comprises a styrenic block copolymer having a glass transition temperature of -130 °F to -30 °F, for example, -130, -120, -110, -100, -90, -80, -70, -60, -50, -40, or -30 °F, including ranges between any of the foregoing values.

In some embodiments, the second polymer only comprises one type of polymer. In some embodiments, the second polymer comprises more than one type of polymer. In some embodiments, the second polymer only comprises one polymer. In some embodiments, the second polymer comprises more than one polymer. In some embodiments, the second polymer comprises the same type of polymer as the first polymer, e.g. both are acrylic, but the glass transition temperature are different.

In some embodiments, the second pressure-sensitive adhesive comprises 0.5% to 80%, or any range or subrange between 0.5% to 80%, by weight of the second polymer based on a total weight of the second pressure-sensitive adhesive. In some embodiments, the second pressure sensitive adhesive comprises 0.5% to 75%, 0.5% to 70%, 0.5% to 65%, 0.5% to 60%, 0.5% to 55%, 0.5% to 50%, 0.5% to 45%, 0.5% to 40%, 0.5% to 35%, 0.5% to 30%, 0.5% to 25%, 0.5% to 20%, 0.5% to 15%, 0.5% to 10%, 0.5% to 5%, or 0.5% to 1% by weight of the second polymer based on a total weight of the second pressure-sensitive adhesive. In some embodiments, the second pressure-sensitive adhesive comprises 1% to 80%, 5% to 80%, 10% to 80%, 15% to 80%, 20% to 80%, 25% to 80%, 30% to 80%, 35% to 80%, 40% to 80%, 45% to 80%, 50% to 80%, 55% to 80%, 60% to 80%, 65% to 80%, 70% to 80%, or 75% to 80% by weight of the second polymer based on a total weight of the second pressure-sensitive adhesive.

In some embodiments, the second pressure-sensitive adhesive comprises a second tackifier. In some embodiments, the second tackifier comprises at least one of a liquid rubber, a hydrocarbon resin such as a C5 aliphatic resin, a C9 aromatic resin, or a C5/C9 copolymer resin; a rosin-based resin such as a rosin, a polymerized rosin, a hydrogenated rosin, or a rosin ester; a terpene resin such as a terpene phenol resin, an aromatic-modified terpene resin, a hydrogenated terpene resin, or a polyterpene resin; a phenolic resin such as a phenol formaldehyde resin, a bisphenol A resin, a novolac resin, or a resorcinol formaldehyde resin; or any combination thereof. In some embodiments, the second pressure-sensitive adhesive does not comprise any one or more of the second tackifiers disclosed herein.

In some embodiments, the second pressure-sensitive adhesive comprises 0.1% to 50%, or any range or subrange between 0.1% to 50%, by weight of a second tackifier based on a total weight of the second pressure-sensitive adhesive. In some embodiments, the second pressure-sensitive adhesive comprises 0.1% to 45%, 0.1% to 40%, 0.1% to 35%, 0.1% to 30%, 0.1% to 25%, 0.1% to 20%, 0.1% to 15%, 0.1% to 10%, 0.1% to 5%, 0.1% to 1%, or 0.1% to 0.5% of a second tackifier based on a total weight of the second pressure-sensitive adhesive. In some embodiments, the second pressure-sensitive adhesive comprises 0.5% to 50%, 1% to 50%, 5% to 50%, 10% to 50%, 15% to 50%, 20% to 50%, 25% to 50%, 30% to 50%, 35% to 50%, 40% to 50%, or 45% to 50% by weight of a second tackifier based on a total weight of the second pressure-sensitive adhesive.

In some embodiments, the second pressure-sensitive adhesive comprises a second plasticizer. In some embodiments, the second plasticizer comprises at least one of a phthalate ester such as a dioctyl phthalate (DOP), a dibutyl phtalate (DBP), a di-isononyl phtalate (DINP), a di-isodecyl phtalate (DIDP), or a butylbenzyl phtalate (BBP); an aliphatic dibasic ester such as a dioctyl adipate, a dioctyl sebacate, a dibutyl sebacate, or an isodecyl succinate; a fatty acid ester such as a butyl oleate or an acetylricinoleic acid methyl ester; a polyalkylene glycol ester such as a diethylene glycol dibenzoate, a triethylene glycol dibenzoate, or a pentaerythritol ester; a phosphate such as a tricresyl phosphate or a tributyl phosphate; a trimellitate; a polystyrene or a poly-α-methylstyrene; a hydrocarbon polymer such as a polybutadiene, a polybutene, a polyisobutylene, a poly-(butadieneacrylonitrile), or a polychloroprene; a paraffinic oil; a naphthenic oil; a process oil; a polyether polyol such as a polyethylene glycol, a polypropylene glycol, or polytetramethylene glycol; a polyether substituting ester or ether group for the hydroxyl group of the polyether polyol; an epoxidized plasticizer such as an epoxidized soybean oil or an epoxidized benzyl stearate; a polyester plasticizer which are obtained by esterifying a dibasic acid such as a sebacic acid, an adipic acid, an azelaic acid, or a phthalic acid and a dihydric alcohol such as an ethylene glycol, a diethylene glycol, a triethylene glycol, a propylene glycol, or a dipropylene glycol; or any combination thereof. In some embodiments, the second pressure-sensitive adhesive does not comprise any one or more of the second plasticizers disclosed herein.

In some embodiments, the second pressure-sensitive adhesive comprises 0.1% to 50%, or any range or subrange between 0.1% to 50%, by weight of a second plasticizer based on a total weight of the second pressure-sensitive adhesive. In some embodiments, the second pressure-sensitive adhesive comprises 0.1% to 45%, 0.1% to 40%, 0.1% to 35%, 0.1% to 30%, 0.1% to 25%, 0.1% to 20%, 0.1% to 15%, 0.1% to 10%, 0.1% to 5%, 0.1% to 1%, or 0.1% to 0.5% of a second plasticizer based on a total weight of the first pressure-sensitive adhesive. In some embodiments, the second pressure-sensitive adhesive comprises 0.5% to 50%, 1% to 50%, 5% to 50%, 10% to 50%, 15% to 50%, 20% to 50%, 25% to 50%, 30% to 50%, 35% to 50%, 40% to 50%, or 45% to 50% by weight of a second plasticizer based on a total weight of the second pressure-sensitive adhesive.

In some embodiments, the second pressure-sensitive adhesive comprises an additive. In some embodiments, the additive comprises at least one of a crosslinker, a catalyst, an adhesion promoter, a fire retardant, a filler, an antioxidant, a pigment, a colorant, a dye, a binding agent, an antistatic agent, a stabilizer, a UV stabilizer, an anti-blocking agent, a UV absorber, a surfactant, a wax, or any combination thereof. In some embodiments, the additive is different from the tackifier. In some embodiments, the additive is different from the plasticizer. In some embodiments, the second pressure-sensitive adhesive does not comprise any one or more of the additives disclosed herein.

In some embodiments, the additive comprises a crosslinker. In some embodiments, the crosslinker comprises a neutral curing agent. In some embodiments, the crosslinker comprises at least one of ketoxime silanes, alkoxysilanes, acetoxysilanes, isopropenoxy silanes, a partial hydrolysate/condensate of said silanes, or any combination thereof. In some embodiments, the crosslinker comprises an organosilane, which may contain at least 2 or at least 3 hydrolyzable groups in one molecule and/or its partial hydrolysate. In some embodiments, a hydrolyzable group in such an organosilane or its partial hydrolysate includes at least one of a ketoxime group, an alkoxy group, an acetoxy group, an isopropenoxy group, or any combination thereof. In some embodiments, the crosslinker comprises an organic titanate, a thermal radical initiator, a UV radical initiator, or any combination thereof. In some embodiments, the crosslinker comprises ketoxime silanes. In some embodiments, a ketoxime silane comprises at least one of tetrakis(methylethylketoxime)silane, methyltris(dimethylketoxime)silane, methyltris(methylethylketoxime)silane, ethyltris(methylethylketoxime)silane, methyltris(methyl isobutyl ketoxime)silane, vinyl tris(methylethylketoxime)silane or any combination thereof. In some embodiments, the crosslinker comprises an alkoxysilane. In some embodiments, the alkoxysilane comprises at least one of methyltrimethoxysilane, vinyltrimethoxysilane, phenyltrimethoxysilane, vinyltriethoxy silane, or any combination thereof. In some embodiments, the crosslinker comprises an acetoxysilane. In some embodiments, the acetoxysilane comprises at least one of methyltriacetoxysilane, vinyltriacetoxysilane, or any combination thereof. In some embodiments, the crosslinker comprises an isopropenoxy silane. In some embodiments, the isopropenoxy silane comprises at least one of methyltriisopropenoxysilane, vinyltriisopropenoxysilane, phenyltriisopropenoxysilane, or any combination thereof. In some embodiments, the crosslinker comprises a partial hydrolysate/condensate of any one of the silanes disclosed herein. In some embodiments, the crosslinker comprises at least one of methyltris(methylethylketoxime)silane, vinyltris(methylethylketoxime)silane, or any combination thereof. In some embodiments, the second pressure-sensitive adhesive does not comprise any one or more of the crosslinkers disclosed herein.

In some embodiments, the additive comprises a catalyst. In some embodiments, the catalyst comprises at least one of an organic tin, an organic platinum, triethanolamine titanate, dimethyltin dioleate, dibutyltin diacetate, stannous octoate, dibutyltin dioctoate, dibutyltin dilaurate, dibutyltin dimethoxide, dibutyltin bis(acetylacetonate), dibutyltin bis(benzylmalate), dimethyltin dimethoxide, dimethyltin diacetate, dioctyltin dioctate, dioctyltin dilaurate, tin dioctate, tin laurate, tetraisopropyl titanate, tetra-n-butyl titanate, tetra-tertiary butyl titanate, tetra-n-propyl titanate, tetra-2-ethylhexyl titanate, diisopropyl di-tertiary butyl titanate, dimethoxy titanium bisacetylacetonate, diisopropoxy titanium bisethyl acetoacetate, di-tertiary butoxy titanium bisethyl acetoacetate, di-tertiary butoxy titanium bismethyl acetoacetate, or any combination thereof. In some embodiments, the second pressure-sensitive adhesive does not comprise any one or more of the catalysts disclosed herein.

In some embodiments, the additive comprises an adhesion promoter. In some embodiments, the adhesion promoter comprises at least one of dichlorodimethyl silane, a chlorinated polyolefin, an organosilane, an organotitanate, a zircoaluminate, a zirconate, an acrylate, an aryl phosphate ester, an alkyl phosphate ester, an aryl alkyl phosphate ester, a metal organic, a silica, a fumed silica, N-(2-aminoethyl)-3-aminopropyltrimethoxysilane, vinyl tris(2-methoxyethoxy)silane, 3-methacryloxypropyltrimethoxysilane, 2-(3,4-epoxycyclohexyl)ethyl trimethoxysilane, 3-glycidoxypropyltrimethoxysilane, 3-glycidoxypropylmethyldiethoxysilane, N-(2-aminoethyl)3-aminopropyltrimethoxysilane, 3-aminopropyltriethoxysilane, 3-(N-aminomethylbenzylamino)propyltrimethoxysilane, 3-mercaptopropyltrimethoxysilane, 3-aminopropyltris(methylethylketoxime)silane, 3-glycidoxy propyltriisopropenoxysilane, 3-glycidoxypropylmethyldiisopropenoxysilane, any reaction product thereof, or any combination thereof. In some embodiments, the adhesion promoter is a reaction product of dichlorodimethylsilane and a silica agent. In some embodiments, the silica agent comprises a fumed silica. In some embodiments, the adhesion promoter comprises at least one of tetraethyl orthosilicate, aminopropyltrimethoxysilane, or any combination thereof. In some embodiments, the second pressure-sensitive adhesive does not comprise any one or more of the adhesion promoters disclosed herein.

In some embodiments, the additive comprises a filler. In some embodiments, the filler comprises at least one of nepheline syenite, magnesium oxide, zinc oxide, calcium carbonate, barium sulfate, iron oxide, diatomaceous earth, melamine, quartz, silica, colloidal silica, crystalline silica, precipitated silica, amorphous silica, titanium dioxide, alumina trihydrate, zinc oxide, zirconium oxide, zirconium silicate, zinc borate, chromic oxide, crystalline silica fine powder, amorphous silica fine powder, silicone rubber powder, glass, glass bubbles, glass powder, zeolites, silica hydrogen, silica aero gel, calcium silicate, aluminum silicate, aluminum oxide, ferrite, carbon black, graphite, mica, clay, bentonite, ground quartz, kaolin, calcined kaolin, wollastonite, hydroxyapatite, hydrated alumina, magnesium hydroxide, vermiculite, talcum, slaked lime, or any combination thereof. In some embodiments, the second pressure-sensitive adhesive does not comprise any one or more of the fillers disclosed herein.

In some embodiments, the second pressure-sensitive adhesive comprises 0.1% to 50%, or any range or subrange between 0.1% to 50%, by weight of an additive based on a total weight of the second pressure-sensitive adhesive. In some embodiments, the second pressure-sensitive adhesive comprises 0.1% to 45%, 0.1% to 40%, 0.1% to 35%, 0.1% to 30%, 0.1% to 25%, 0.1% to 20%, 0.1% to 15%, 0.1% to 10%, 0.1% to 5%, 0.1% to 1%, or 0.1% to 0.5% of an additive based on a total weight of the second pressure-sensitive adhesive. In some embodiments, the second pressure-sensitive adhesive comprises 0.5% to 50%, 1% to 50%, 5% to 50%, 10% to 50%, 15% to 50%, 20% to 50%, 25% to 50%, 30% to 50%, 35% to 50%, 40% to 50%, or 45% to 50% by weight of an additive based on a total weight of the second pressure-sensitive adhesive.

In some embodiments, the second pressure-sensitive adhesive has a second glass transition temperature. In some embodiments, the second glass transition temperature of the second pressure-sensitive adhesive is at least 10 °F greater than first glass transition temperature of the first pressure-sensitive adhesive. In some embodiments, the second glass transition temperature of the second pressure-sensitive adhesive is at least 15 °F, at least 20 °F, at least 25 °F, at least 30 °F, at least 40 °F, at least 45 °F, at least 50 °F, at least 55 °F, at least 60 °F, at least 65 °F, at least 70 °F, at least 75 °F, at least 80 °F, at least 85 °F, at least 90 °F, at least 95 °F, at least 100 °F, at least 105 °F, at least 110 °F, at least 115 °F, at least 120 °F, at least 125 °F, at least 130 °F, at least 135 °F, at least 140 °F, at least 145 °F, at least 150 °F, at least 155 °F, at least 160 °F, at least 165 °F, or at least 170 °F greater than first glass transition temperature of the first pressure-sensitive adhesive.

In some embodiments, the second glass transition temperature of the second pressure-sensitive adhesive is 10 °F to 170 °F, or any range or subrange between 10 °F to 170 °F, greater than the first glass transition temperature. In some embodiments, the second glass transition temperature of the second pressure-sensitive adhesive is 10 °F to 165 °F, 10 °F to 160 °F, 10 °F to 155 °F, 10 °F to 150 °F, 10 °F to 145 °F, 10 °F to 140 °F, 10 °F to 135 °F, 10 °F to 130 °F, 10 °F to 125 °F, 10 °F to 120 °F, 10 °F to 115 °F, 10 °F to 110 °F, 10 °F to 105 °F, 10 °F to 100 °F, 10 °F to 95 °F, 10 °F to 90 °F, 10 °F to 85 °F, 10 °F to 80 °F, 10 °F to 75 °F, 10 °F to 70 °F, 10 °F to 65 °F, 10 °F to 60 °F, 10 °F to 55 °F, 10 °F to 50 °F, 10 °F to 45 °F, 10 °F to 40 °F, 10 °F to 35 °F, 10 °F to 30 °F, 10 °F to 25 °F, 10 °F to 20 °F, or 10 °F to 15 °F greater than the first glass transition temperature of the first pressure-sensitive adhesive.

In some embodiments, the second glass transition temperature is at least 10% greater than the first glass transition temperature. In some embodiments, the second glass transition temperature is at least 20%, at least 30%, at least 40%, at least 50%, at least 60%, at least 70%, at least 80%, at least 90%, at least 100%, at least 110%, at least 120%, at least 130%, at least 140%, or at least 150% greater than the first glass transition temperature.

In some embodiments, the second glass transition temperature is 10% to 150%, or any range or subrange between 10% to 150%, greater than the first glass transition temperature. In some embodiments, the second glass transition temperature is 10% to 140%, 10% to 130%, 10% to 120%, 10% to 110%, 10% to 100%, 10% to 90%, 10% to 80%, 10% to 70%, 10% to 60%, 10% to 50%, 10% to 40%, 10% to 30%, or 10% to 20% greater than the first glass transition temperature. In some embodiments, the second glass transition temperature is 20% to 150%, 30% to 150%, 40% to 150%, 50% to 150%, 60% to 150%, 70% to 150%, 80% to 150%, 90% to 150%, 100% to 150%, 110% to 150%, 120% to 150%, 130% to 150%, or 140% to 150% greater than the first glass transition temperature.

In some embodiments, the second glass transition temperature is at least -110 °F, at least -105 °F, at least -100 °F, at least -95 °F, at least -90 °F, at least -85 °F, at least -80 °F, at least -75 °F, at least -70 °F, at least -65 °F, at least -60 °F, at least -55 °F, at least -50 °F, at least -45 °F, at least -40 °F, at least -35 °F, at least -30 °F, at least -25 °F, at least -20 °F, at least -15 °F, at least -10 °F, at least -5 °F, at least 0 °F, at least 5 °F, at least 10 °F, at least 15 °F, at least 20 °F, at least 25 °F, at least 30 °F, at least 35 °F, at least 40 °F, at least 45 °F, or at least 50 °F.

In some embodiments, the second glass transition temperature is -110 °F to 50 °F, or any range or subrange between -110 °F to 50 °F. In some embodiments, the second glass transition temperature is -110 °F to 45 °F, -110 °F to 40 °F, -110 °F to 35 °F, -110 °F to 30 °F, -110 °F to 25 °F, -110 °F to 20 °F, -110 °F to 15 °F, -110 °F to 10 °F, -110 °F to 5 °F, -110 °F to 0 °F, -110 °F to -5 °F, -110 °F to -10 °F, -110 °F to -15 °F, -110 °F to -20 °F, -110 °F to -25 °F, -110 °F to -30 °F, -110 °F to -35 °F, -110 °F to -40 °F, -110 °F to -45 °F, -110 °F to -50 °F, -110 °F to -55 °F, -110 °F to -60 °F, -110 °F to -65 °F, -110 °F to -70 °F, -110 °F to -75 °F, -110 °F to -80 °F, -110 °F to -85 °F, -110 °F to -90 °F, -110 °F to -95 °F, -110 °F to -100 °F, or -110 °F to -105 °F. In some embodiments the second glass transition temperature is -105 °F to 50 °F, -100 °F to 50 °F, -95 °F to 50 °F, -90 °F to 50 °F, -85 °F to 50 °F, -80 °F to 50 °F, -75 °F to 50 °F, -70 °F to 50 °F, -65 °F to 50 °F, -60 °F to 50 °F, -55 °F to 50 °F, -50 °F to 50 °F, -45 °F to 50 °F, -40 °F to 50 °F, -30 °F to 50 °F, -25 °F to 50 °F, -20 °F to 50 °F, -15 °F to 50 °F, -10 °F to 50 °F, -5 °F to 50 °F, 0 °F to 50 °F, 5 °F to 50 °F, 10 °F to 50 °F, 15 °F to 50 °F, 20 °F to 50 °F, 25 °F to 50 °F, 30 °F to 50 °F, 35 °F to 50 °F, 40 °F to 50 °F, or 45 °F to 50 °F.

In some embodiments, the cover tape comprises a release liner. In some embodiments, the release liner covers at least the first adhesive strip, the second adhesive strip, or any combination thereof. In some embodiments, the release liner directly contacts the first adhesive strip. In some embodiments, the release liner directly contacts the second adhesive strip. In some embodiments, before use, the release liner is removed from at least the first adhesive strip, the second adhesive strip, or any combination thereof.

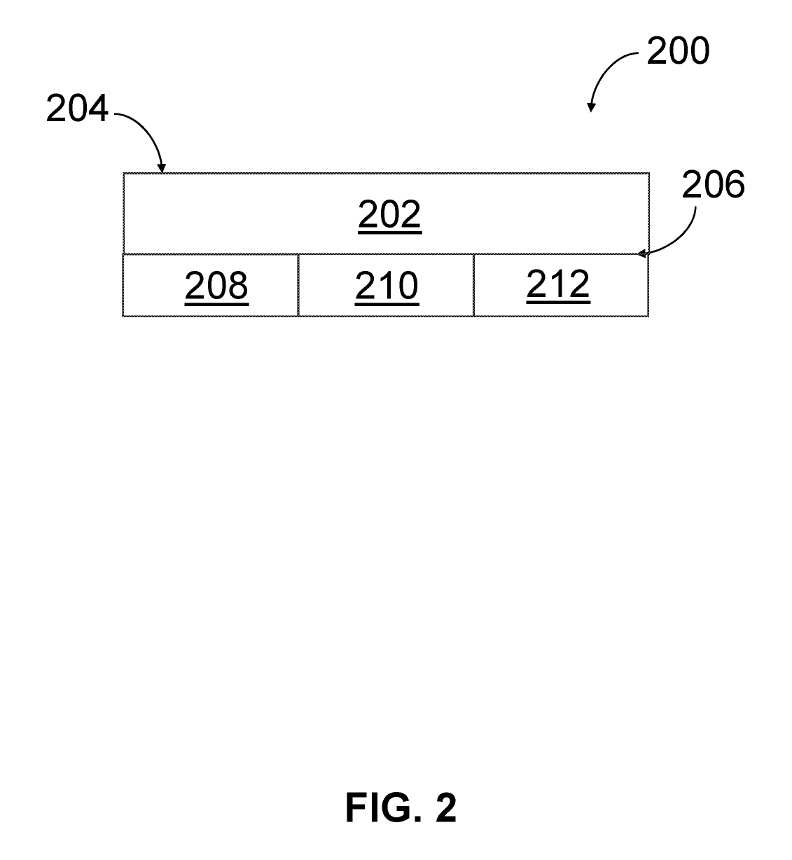

FIG. 2 is a schematic diagram of a cross-section of a self-adhered cover tape 200, according to some embodiments. As shown in FIG. 2, the cover tape 200 comprises a first layer 202. In some embodiments, the first layer 202 has a first surface 204 and a second surface 206. In some embodiments, the cover tape 200 comprises a first adhesive strip 208. In some embodiments, the first adhesive strip 208 is located on the second surface 206 of the first layer 202. In some embodiments, the cover tape 200 comprises a second adhesive strip 210. In some embodiments, the second adhesive strip 210 is located on the second surface 206 of the first layer 202. In some embodiments, the second adhesive strip 210 is adjacent to the first adhesive strip 208. In some embodiments, the cover tape comprises a third adhesive strip 212. In some embodiments, the third adhesive strip 212 is located on the second surface 206 of the first layer 202. In some embodiments, the third adhesive strip 212 is located adjacent to the second adhesive strip 210.

In some embodiments, the first layer 202 comprises any first layer disclosed herein.

In some embodiments, the first adhesive strip 208 comprises any first adhesive strip disclosed herein.

In some embodiments, the second adhesive strip 210 comprises any second adhesive strip disclosed herein.

In some embodiments, the third adhesive strip 212 covers 1% to 50%, or any range of subrange of 1% to 50%, of the second surface 206 of the first layer 202. In some embodiments, the third adhesive strip 212 covers 1% to 45%, 1% to 40%, 1% to 35%, 1% to 30%, 1% to 25%, 1% to 20%, 1% to 15%, 1% to 10%, 1% to 5%, 5% to 50%, 10% to 50%, 15% to 50%, 20% to 50%, 25% to 50%, 30% to 50%, 35% to 50%, 40% to 50%, or 45% to 50% of the second surface 206 of the first layer 202.

In some embodiments, the third adhesive strip 212 comprises a third pressure-sensitive adhesive. In some embodiments, the third pressure-sensitive adhesive of the third adhesive strip 212 is the same pressure-sensitive adhesive as the first pressure-sensitive adhesive of the first adhesive strip 208. In some embodiments, the third pressure-sensitive adhesive of the third adhesive strip 212 is a similar pressure-sensitive adhesive to the first pressure-sensitive adhesive of the first adhesive strip 208. In some embodiments, the third pressure-sensitive adhesive of the third adhesive strip 212 is a substantially similar pressure-sensitive adhesive to the first pressure-sensitive adhesive of the first adhesive strip 208. In some embodiments, the third pressure-sensitive adhesive of the third adhesive strip 212 is different from the second pressure-sensitive adhesive of the second adhesive strip 210.

In some embodiments, the third pressure-sensitive adhesive of the third adhesive strip 212 has a third glass transition temperature. In some embodiments, the third glass transition temperature of the third pressure-sensitive adhesive is the same as the first glass transition temperature of the first pressure-sensitive adhesive. In some embodiments, the third glass transition temperature of the third pressure-sensitive adhesive is within 10 °F of the first glass transition temperature of the first pressure-sensitive adhesive. In some embodiments, the third glass transition temperature of the third pressure-sensitive adhesive is within 9 °F, 8 °F, 7 °F, 6 °F, 5 °F, 4 °F, 3 °F, 2 °F, 1 °F or 0 °F of the first glass transition temperature of the first pressure-sensitive adhesive.

In some embodiments, the third glass transition temperature of the third pressure-sensitive adhesive is within 0 °F to 10 °F, or any range or subrange between 0 °F to 10 °F, of the first glass transition temperature of the third pressure-sensitive adhesive. In some embodiments, the third glass transition temperature of the third pressure-sensitive adhesive is within 0 °F to 9 °F, 0 °F to 8 °F, 0 °F to 7 °F, 0 °F to 6 °F, 0 °F to 5 °F, 0 °F to 4 °F, 0 °F to 3 °F, 0 °F to 2 °F, 0 °F to 1 °F, 1 °F to 10 °F, 2 °F to 10 °F, 3 °F to 10 °F, 4 °F to 10 °F, 5 °F to 10 °F, 6 °F to 10 °F, 7 °F to 10 °F, 8 °F to 10 °F, or 9 °F to 10 °F of the first glass transition temperature of the first pressure-sensitive adhesive.

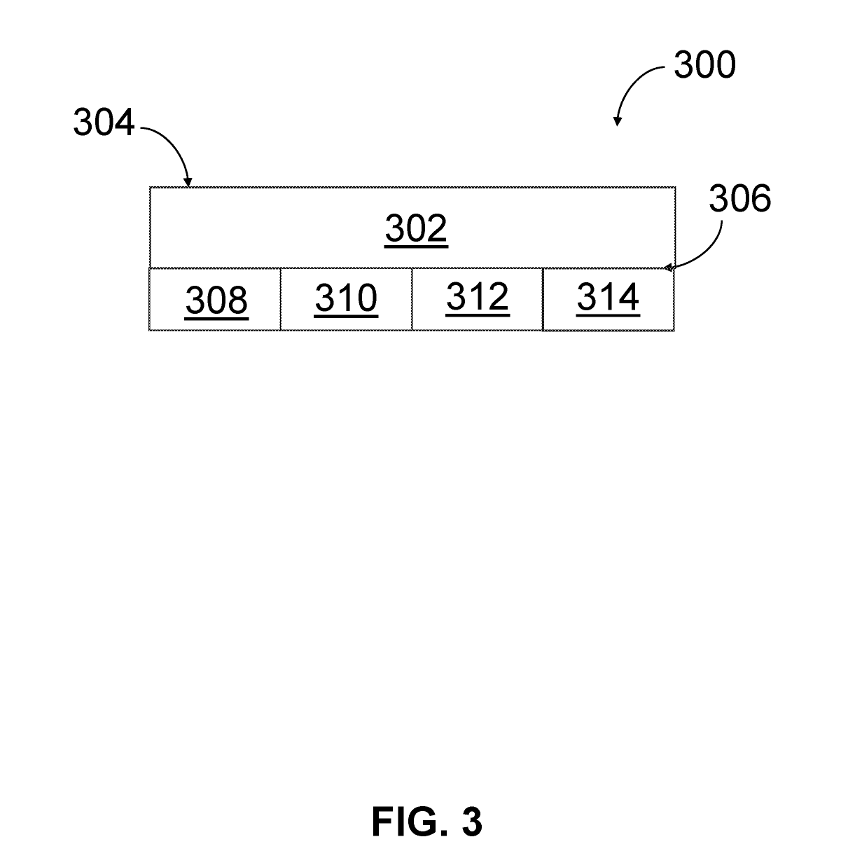

FIG. 3 is a schematic diagram of a cross-section of a self-adhered cover tape 300, according to some embodiments. As shown in FIG. 3, the cover tape 300 comprises a first layer 302. In some embodiments, the first layer 302 has a first surface 304 and a second surface 306. In some embodiments, the cover tape 300 comprises a first adhesive strip 308. In some embodiments, the first adhesive strip 308 is located on the second surface 306 of the first layer 302. In some embodiments, the cover tape 300 comprises a second adhesive strip 310. In some embodiments, the second adhesive strip 310 is located on the second surface 306 of the first layer 302. In some embodiments, the second adhesive strip 310 is adjacent to the first adhesive strip 308. In some embodiments, the cover tape comprises a third adhesive strip 312. In some embodiments, the third adhesive strip 312 is located on the second surface 306 of the first layer 302. In some embodiments, the third adhesive strip 312 is adjacent to the second adhesive strip 310. In some embodiments, the cover tape 300 comprises a fourth adhesive strip 314. In some embodiments, the fourth adhesive strip 314 is located on the second surface 306 of the first layer 302. In some embodiments, the fourth adhesive strip 314 is adjacent to the third adhesive strip 312.

In some embodiments, the first layer 302 comprises any first layer disclosed herein.

In some embodiments, the first adhesive strip 308 comprises any first adhesive strip disclosed herein.

In some embodiments, the second adhesive strip 310 comprises any second adhesive strip disclosed herein.

In some embodiments, the third adhesive strip 312 comprises any third adhesive strip disclosed herein.

In some embodiments, the fourth adhesive strip 314 covers 1% to 50%, or any range of subrange of 1% to 50%, of the second surface 306 of the first layer 302. In some embodiments, the fourth adhesive strip 314 covers 1% to 45%, 1% to 40%, 1% to 35%, 1% to 30%, 1% to 25%, 1% to 20%, 1% to 15%, 1% to 10%, 1% to 5%, 5% to 50%, 10% to 50%, 15% to 50%, 20% to 50%, 25% to 50%, 30% to 50%, 35% to 50%, 40% to 50%, or 45% to 50% of the second surface 306 of the first layer 302.

In some embodiments, the fourth adhesive strip 314 comprises a fourth pressure-sensitive adhesive. In some embodiments, the fourth pressure-sensitive adhesive of the fourth adhesive strip 314 is the same pressure-sensitive adhesive as the second pressure-sensitive adhesive of the second adhesive strip 310. In some embodiments, the fourth pressure-sensitive adhesive of the fourth adhesive strip 314 is a similar pressure-sensitive adhesive to the second pressure-sensitive adhesive of the second adhesive strip 310. In some embodiments, the fourth pressure-sensitive adhesive of the fourth adhesive strip 314 is a substantially similar pressure-sensitive adhesive to the second pressure-sensitive adhesive of the second adhesive strip 310. In some embodiments, the fourth pressure-sensitive adhesive of the fourth adhesive strip 314 is different from at least one of the first pressure-sensitive adhesive of the first adhesive strip 308, the third pressure-sensitive adhesive of the third strip 312, or any combination thereof.

In some embodiments, the fourth pressure-sensitive adhesive of the fourth adhesive strip 314 has a fourth glass transition temperature. In some embodiments, the fourth glass transition temperature of the fourth pressure-sensitive adhesive is the same as the second glass transition temperature of the second pressure-sensitive adhesive. In some embodiments, the fourth glass transition temperature of the fourth pressure-sensitive adhesive is within 10 °F of the second glass transition temperature of the second pressure-sensitive adhesive. In some embodiments, the fourth glass transition temperature of the fourth pressure-sensitive adhesive is within 9 °F, 8 °F, 7 °F, 6 °F, 5 °F, 4 °F, 3 °F, 2 °F, 1 °F or 0 °F of the second glass transition temperature of the second pressure-sensitive adhesive.

In some embodiments, the fourth glass transition temperature of the fourth pressure-sensitive adhesive is within 0 °F to 10 °F, or any range or subrange between 0 °F to 10 °F, of the second glass transition temperature of the second pressure-sensitive adhesive. In some embodiments, the fourth glass transition temperature of the fourth pressure-sensitive adhesive is within 0 °F to 9 °F, 0 °F to 8 °F, 0 °F to 7 °F, 0 °F to 6 °F, 0 °F to 5 °F, 0 °F to 4 °F, 0 °F to 3 °F, 0 °F to 2 °F, 0 °F to 1 °F, 1 °F to 10 °F, 2 °F to 10 °F, 3 °F to 10 °F, 4 °F to 10 °F, 5 °F to 10 °F, 6 °F to 10 °F, 7 °F to 10 °F, 8 °F to 10 °F, or 9 °F to 10 °F of the second glass transition temperature of the second pressure-sensitive adhesive.

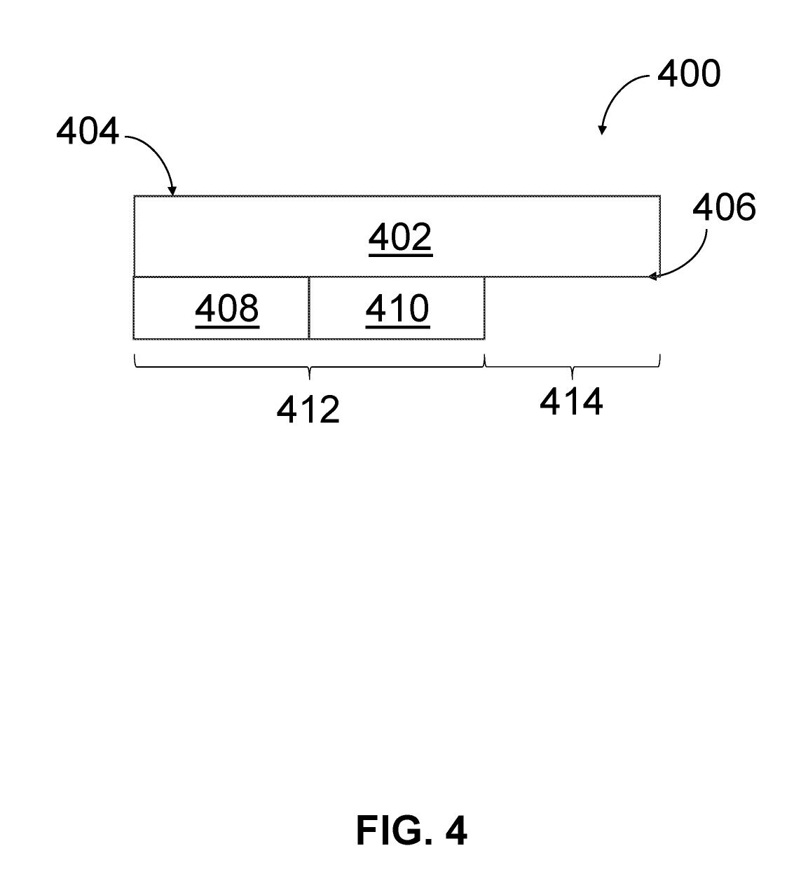

FIG. 4 is a schematic diagram of a cross-section of a self-adhered cover tape 400, according to some embodiments. As shown in FIG. 4, the cover tape 400 comprises a first layer 402. In some embodiments, the first layer 402 has a first surface 404 and a second surface 406. In some embodiments, the second surface 406 of the first layer 402 has an adhesive surface portion 412. In some embodiments, the second surface 406 of the first layer 402 has a heat-weldable surface portion 414. In some embodiments, the heat-weldable surface portion 414 is adjacent to the adhesive surface portion 412.

In some embodiments, the first layer 402 comprises any first layer disclosed herein.

In some embodiments, the adhesive surface portion 412 comprises a first adhesive strip 408. In some embodiments, the first adhesive strip 408 comprises any first adhesives strip disclosed herein. In some embodiments, the adhesive surface portion 412 comprises a second adhesive strip 410. In some embodiments, the second adhesive strip 408 comprises any second adhesive strip disclosed herein.

In some embodiments, the first adhesive strip 408 covers 1% to 50%, or any range of subrange of 1% to 50%, of the adhesive surface portion 412 of the second surface 406. In some embodiments, the first adhesive strip 408 covers 1% to 45%, 1% to 40%, 1% to 35%, 1% to 30%, 1% to 25%, 1% to 20%, 1% to 15%, 1% to 10%, 1% to 5%, 5% to 50%, 10% to 50%, 15% to 50%, 20% to 50%, 25% to 50%, 30% to 50%, 35% to 50%, 40% to 50%, or 45% to 50% of the adhesive surface portion 412 of the second surface 406.

In some embodiments, the second adhesive strip 410 covers 1% to 50%, or any range of subrange of 1% to 50%, of the adhesive surface portion 412 of the second surface 406. In some embodiments, the second adhesive strip 410 covers 1% to 45%, 1% to 40%, 1% to 35%, 1% to 30%, 1% to 25%, 1% to 20%, 1% to 15%, 1% to 10%, 1% to 5%, 5% to 50%, 10% to 50%, 15% to 50%, 20% to 50%, 25% to 50%, 30% to 50%, 35% to 50%, 40% to 50%, or 45% to 50% of the adhesive surface portion 412 of the second surface 406.

In some embodiments, the first adhesive strip 408 and the second adhesive strip 410, in combination, cover 2% to 80%, or any range or subrange of 2% to 80%, of the second surface 406 of the first layer 402. In some embodiments, the first adhesive strip 408 and the second adhesive strip 410, in combination, cover 2% to 75%, 2% to 70%, 2% to 65%, 2% to 60%, 2% to 55%, 2% to 50%, 2% to 45%, 2% to 40%, 2% to 35%, 2% to 30%, 2% to 25%, 2% to 20%, 2% to 15%, 2% to 10%, or 2% to 5% of the second surface 406 of the first layer 402. In some embodiments, the first adhesive strip 408 and the second adhesive strip 410, in combination, cover 5% to 80%, 10% to 80%, 15% to 80%, 20% to 80%, 25% to 80%, 30% to 80%, 35% to 80%, 40% to 80%, 45% to 80%, 50% to 80%, 55% to 80%, 60% to 80%, 65% to 80%, 70% to 80% or 75% to 80% of the second surface 406 of the first layer 402.

In some embodiments, the adhesive surface portion 412 covers 2% to 80%, or any range or subrange of 2% to 80%, of the second surface 406 of the first layer 402. In some embodiments, the adhesive surface portion 412 covers 2% to 75%, 2% to 70%, 2% to 65%, 2% to 60%, 2% to 55%, 2% to 50%, 2% to 45%, 2% to 40%, 2% to 35%, 2% to 30%, 2% to 25%, 2% to 20%, 2% to 15%, 2% to 10%, or 2% to 5% of the second surface 406 of the first layer 402. In some embodiments, the adhesive surface portion 412 covers 5% to 80%, 10% to 80%, 15% to 80%, 20% to 80%, 25% to 80%, 30% to 80%, 35% to 80%, 40% to 80%, 45% to 80%, 50% to 80%, 55% to 80%, 60% to 80%, 65% to 80%, 70% to 80% or 75% to 80% of the second surface 406 of the first layer 402.

In some embodiments, the adhesive surface portion 412 comprises any number of adhesive strips, for example, including and not limited to, a third adhesive strip and a fourth adhesive strip.

In some embodiments, the heat-weldable surface portion 414 comprises a material capable of being heat-welded. In some embodiments, the heat-weldable surface portion 414 comprises the same material as the first layer 402. In some embodiments, the heat-weldable surface portion 414 can comprise any material listed as suitable for the first layer 402. In some embodiments, the heat-weldable surface portion 414 does not comprises an adhesive. In some embodiments, while in FIG. 4, the heat-weldable surface portion 414 is depicted as being thinner than the adhesive surface portion 412, the heat-weldable surface portion 414 can have any thickness, including but not limited to, a thickness that is greater than, equal to, or less than a thickness of the adhesive surface portion 412.

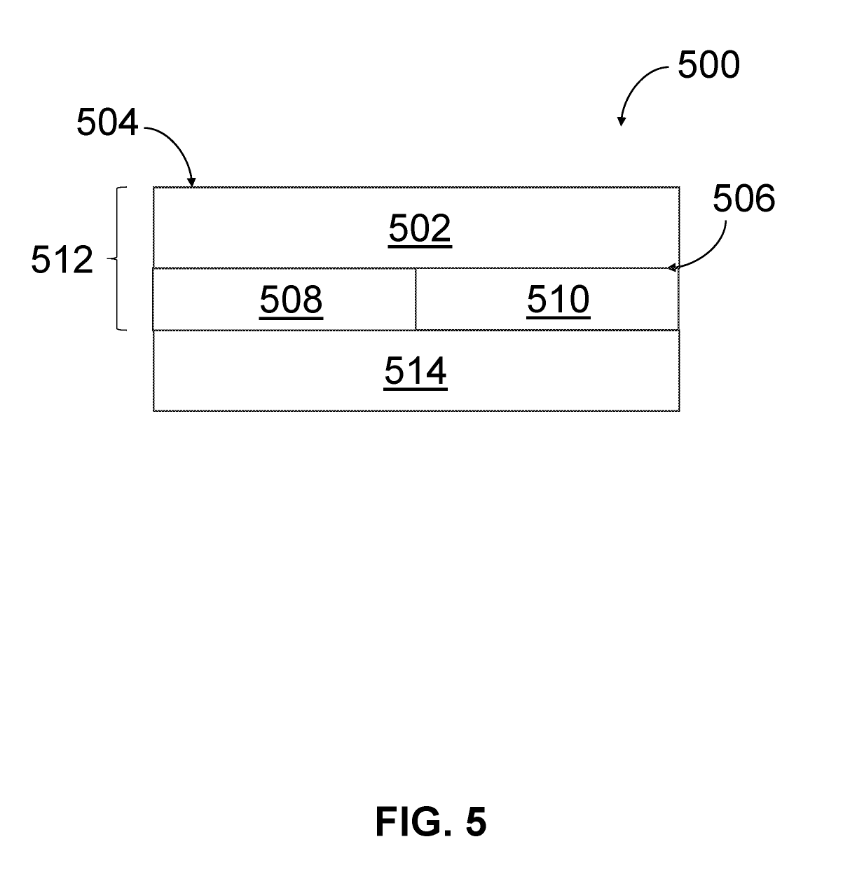

Some embodiments relate to a roofing system. FIG. 5 is a schematic diagram of a cross-section of a roofing system 500, according to some embodiments. As shown in FIG. 5, the roofing system 500 comprises at least one roofing substrate 514 and a cover tape 512. In some embodiments, the cover tape 512 comprises a first layer 502. In some embodiments, the first layer 502 has a first surface 504 and a second surface 506. In some embodiments, the cover tape 512 comprises a first adhesive strip 508. In some embodiments, the first adhesive strip 508 is located on the second surface 506 of the first layer 502. In some embodiments, the cover tape 512 comprises a second adhesive strip 510. In some embodiments, the second adhesive strip 510 is located on the second surface 506 of the first layer 502. In some embodiments, the second adhesive strip 510 is adjacent to the first adhesive strip 508. In some embodiments, the cover tape 512 directly contacts the at least one roofing substrate 514. In some embodiments, the first adhesive strip 508 directly contacts the at least one roofing substrate 514. In some embodiments, the second adhesive strip 510 directly contacts the at least one roofing substrate 514.

In some embodiments, the roofing system 500 comprises at least one roofing substrate 514. In some embodiments, the at least one roofing substrate 514 comprises at least one of an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a building structure, a high density cover board, a cement board, concrete, a base sheet, a pipe, a chimney, a wax paper, a roof shingle, a mat, a fabric, a glass mat, a fiberglass mat, a woven mat, a nonwoven mat, a fabric, a polyester mat, a scrim, a coated scrim, a metal, or any combination thereof.

In some embodiments, the at least one roofing substrate 514 comprises a metal layer and a membrane. In some embodiments, the metal layer comprises an edge metal layer. In some embodiments, the metal layer comprises a metal flashing layer. In some embodiments, the metal layer comprises an edge metal flashing layer. In some embodiments, the metal layer comprises a metal strip. In some embodiments, the metal layer comprises a gravel stop. In some embodiments, the metal layer comprises a metal flange. In some embodiments, the metal layer comprises a metal curb. In some embodiments, the roofing membrane comprises a single-ply membrane. In some embodiments, the roofing membrane comprises a multi-ply membrane. In some embodiments, the roofing membrane comprises a reinforcement. For example, in some embodiments, the roofing membrane is a reinforced membrane. In some embodiments, the reinforcement comprises at least one of a scrim, a woven fabric, a non-woven fabric, a metal foil, a fiberglass mat, a polyester mat, a spunbond mat, or any combination thereof. In some embodiments, the roofing membrane comprises at least one sheet. In some embodiments, the roofing membrane comprises only one sheet. In some embodiments, the roofing membrane comprises a plurality of sheets. In some embodiments, the roofing membrane comprises at least one polymer. In some embodiments, the roofing membrane comprises at least one of a thermoplastic polyolefin (TPO), a polyvinylchloride (PVC), an ethylene-propylene diene monomer (EPDM), or any combination thereof.

In some embodiments, the metal layer is located adjacent to the membrane. In some embodiments, the metal layer abuts the membrane. In some embodiments, at least a portion of the metal layer covers at least a portion of the membrane. In some embodiments, 1% to 100%, or any range or subrange between 1% to 100%, of the metal layer covers at least a portion of the membrane. In some embodiments, 1% to 90%, 1% to 80%, 1% to 70%, 1% to 60%, 1% to 50%, 1% to 40%, 1% to 30%, 1% to 20%, or 1% to 10% of the metal layer covers at least a portion of the membrane. In some embodiments, 10% to 100%, 20% to 100%, 30% to 100%, 40% to 100%, 50% to 100%, 60% to 100%, 70% to 100%, 80% to 100%, or 90% to 100% of the metal layer covers at least a portion of the membrane.

In some embodiments, at least a portion of the metal layer covers 1% to 50%, or any range or subrange between 1% to 50%, of the membrane. In some embodiments, at least a portion of the metal layer covers 1% to 45%, 1% to 40%, 1% to 35%, 1% to 30%, 1% to 25%, 1% to 20%, 1% to 15%, 1% to 10%, or 1% to 5% of the membrane. In some embodiments, at least a portion of the metal layer covers 5% to 50%, 10% to 50%, 15% to 50%, 20% to 50%, 25% to 50%, 30% to 50%, 35% to 50%, 40% to 50%, or 45% to 50% of the membrane.

In some embodiments, the roofing system 500 comprises a cover tape 512. In some embodiments, the cover tape 512 is located on the at least one roofing substrate 514. In some embodiments, the cover tape 512 comprises any one or more of the cover tapes disclosed herein. In some embodiments, when installed on the at least one roofing substrate 514, the cover tape 512 is adhered to the at least one roofing substrate by at least a first adhesive strip 508 and a second adhesive strip 510, as disclosed herein.

In some embodiments, when the at least one roofing substrate comprises a metal layer and a membrane, the cover tape can comprise an adhesive surface portion and a heat-weldable surface portion. When the cover tape is installed on the at least one roofing substrate, the adhesive surface portion is adhered to the metal layer by at least a first adhesive strip and a second adhesive strip, as disclosed herein, and the heat-weldable surface portion is heat-welded to the membrane.

In some embodiments, when the at least one roofing substrate comprises a metal layer and a membrane, the metal layer is located between the membrane and the cover tape, such that the first adhesive strip is adhered to the metal layer and the second adhesive strip is adhered to the membrane. In some embodiments, when the at least one roofing substrate comprises a metal layer and a membrane, the metal layer is located between the membrane and the cover tape, such that the first adhesive strip is adhered to the membrane and the second adhesive strip is adhered to the metal layer. In some embodiments, when the at least one roofing substrate comprises a metal layer and a membrane, the metal layer is located between the membrane and the cover tape, such that the first adhesive strip is adhered to the metal layer and the membrane and the second adhesive strip is adhered to the membrane. In some embodiments, when the at least one roofing substrate comprises a metal layer and a membrane, the metal layer is located between the membrane and the cover tape, such that the first adhesive strip is adhered to the metal layer and the second adhesive strip is adhered to the metal layer and the membrane. In some embodiments, when the at least one roofing substrate comprises a metal layer and a membrane, the metal layer is located between the membrane and the cover tape, such that the first adhesive strip is adhered to the metal layer; the second adhesive strip is adhered to at least one of the metal layer, the membrane, or any combination thereof; and the third adhesive strip is adhered to the membrane.

In some embodiments, when the at least one roofing substrate comprises a metal layer and a membrane, at least a portion of the cover tape covers at least a portion of the metal layer. In some embodiments, 1% to 99%, or any range or subrange between 1% to 99%, of the cover tape covers at least a portion of the metal layer. In some embodiments, 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% of the cover tape covers at least a portion of the metal layer. In some embodiments, 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% of the cover tape covers at least a portion of the metal layer.

In some embodiments, at least a portion of the cover tape covers 1% to 100%, or any range or subrange between 1% to 100%, of the metal layer. In some embodiments, at least a portion of the cover tape covers 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% of the metal layer. In some embodiments, at least a portion of the cover tape covers 5% to 100%, 10% to 100%, 15% to 100%, 20% to 100%, 25% to 100%, 30% to 100%, 35% to 100%, 40% to 100%, 45% to 100%, 50% to 100%, 55% to 100%, 60% to 100%, 65% to 100%, 70% to 100%, 75% to 100%, 80% to 100%, 85% to 100%, 90% to 100%, or 95% to 100% of the metal layer.

In some embodiments, when the at least one roofing substrate comprises a metal layer and a membrane, at least a portion of the cover tape covers at least a portion of the membrane. In some embodiments, 1% to 99%, or any range or subrange between 1% to 99%, of the cover tape covers at least a portion of the membrane. In some embodiments, 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% of the cover tape covers at least a portion of the membrane. In some embodiments, 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% of the cover tape covers at least a portion of the membrane.

In some embodiments, at least a portion of the cover tape covers 1% to 100%, or any range or subrange between 1% to 100%, of the membrane. In some embodiments, at least a portion of the cover tape covers 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% of the membrane. In some embodiments, at least a portion of the cover tape covers 5% to 100%, 10% to 100%, 15% to 100%, 20% to 100%, 25% to 100%, 30% to 100%, 35% to 100%, 40% to 100%, 45% to 100%, 50% to 100%, 55% to 100%, 60% to 100%, 65% to 100%, 70% to 100%, 75% to 100%, 80% to 100%, 85% to 100%, 90% to 100%, or 95% to 100% of the membrane.

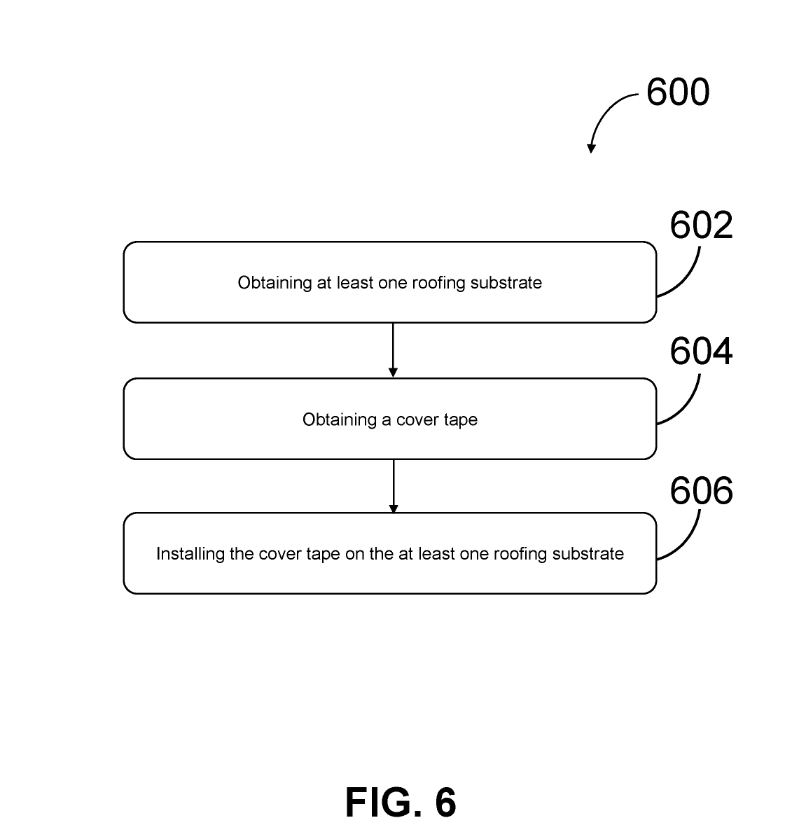

FIG. 6 is a flowchart of a method of installation 600, according to some embodiments. As shown in FIG. 6, the method of installation 600 may comprise one or more of the following steps: obtaining 602 at least one roofing substrate, obtaining 604 a cover tape, installing 606 the cover tape on the roofing substrate.

At step 602, in some embodiments, the method comprises obtaining at least one roofing substrate. In some embodiments, the at least one roofing substrate comprises at least one of an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a building structure, a high density cover board, a cement board, concrete, a base sheet, a pipe, a chimney, a wax paper, a roof shingle, a mat, a fabric, a glass mat, a fiberglass mat, a woven mat, a nonwoven mat, a fabric, a polyester mat, a scrim, a coated scrim, a metal, or any combination thereof.

In some embodiments, the at least one roofing substrate 514 comprises a metal layer and a membrane. In some embodiments, the metal layer comprises an edge metal layer. In some embodiments, the metal layer comprises a metal flashing layer. In some embodiments, the metal layer comprises an edge metal flashing layer. In some embodiments, the metal layer comprises a metal strip. In some embodiments, the metal layer comprises a gravel stop. In some embodiments, the metal layer comprises a metal flange. In some embodiments, the metal layer comprises a metal curb. In some embodiments, the roofing membrane comprises a single-ply membrane. In some embodiments, the roofing membrane comprises a multi-ply membrane. In some embodiments, the roofing membrane comprises a reinforcement. For example, in some embodiments, the roofing membrane is a reinforced membrane. In some embodiments, the reinforcement comprises at least one of a scrim, a woven fabric, a non-woven fabric, a metal foil, a fiberglass mat, a polyester mat, a spunbond mat, or any combination thereof. In some embodiments, the roofing membrane comprises at least one sheet. In some embodiments, the roofing membrane comprises only one sheet. In some embodiments, the roofing membrane comprises a plurality of sheets. In some embodiments, the roofing membrane comprises at least one polymer. In some embodiments, the roofing membrane comprises at least one of a thermoplastic polyolefin (TPO), a polyvinylchloride (PVC), an ethylene-propylene diene monomer (EPDM), or any combination thereof.

At step 604, in some embodiments, the method comprises obtaining a cover tape. In some embodiments, the cover tape comprises any one or more of the cover tapes disclosed herein. In some embodiments, the cover tape comprises at least a first adhesive strip and a second adhesive strip. In some embodiments, the cover tape comprises an adhesive surface portion and a heat-weldable surface portion. In some embodiments, the adhesive surface portion comprises at least a first adhesive strip and a second adhesive strip.

At step 606, in some embodiments, the method comprises installing the cover tape on the at least one roofing substrate. In some embodiments, the installing comprises adhering the cover tape to the at least one roofing substrate. In some embodiments, the installing comprises adhering at least the first adhesive strip and the second adhesive strip to the at least one roofing substrate. In some embodiments, the installing comprises covering the at least one roofing substrate with the cover tape. In some embodiments, the installing comprises placing the cover tape on the at least one roofing substrate. In some embodiments, the installing comprises bonding the cover tape to the at least one roofing substrate. In some embodiments, the installing comprises directly contacting the cover tape to the at least one roofing substrate. In some embodiments, when the at least one roofing substrate comprises a membrane and a metal layer, the installing comprises adhering the adhesive surface portion of the cover tape to the metal layer. In some embodiments, when the at least one roofing substrate comprises a membrane and a metal layer, the installing comprises heat welding the heat-weldable surface portion of the cover tape to the membrane.

Any one or more of the embodiments disclosed herein shall be understood to be combinable without departing from the scope or spirit of the disclosure.

### EXAMPLE 1

A cover tape comprises a first layer having a first surface and a second surface opposite the first surface. The cover tape comprises, on the second surface, a first adhesive strip and a second adhesive strip. The second adhesive strip is adjacent to the first adhesive strip. The first adhesive strip covers 50% of the second surface of the first layer and the second adhesive strip covers 50% of the second surface of the first layer. The first adhesive strip comprises a first pressure-sensitive adhesive having a glass transition temperature of -120 °F to -100 °F. The second adhesive strip comprises a second pressure-sensitive adhesive having a glass temperature of 30 °F to 50 °F. Due to the cover tape having the first and second adhesive strips having different glass transition temperatures, the cover tape remains tacky at both low temperatures, such as less than 0 °F, and high temperatures, such as greater than 120 °F. Additionally, due to the presence of the first and second adhesive strips having different glass transition temperatures, the cover tape performs better than conventional cover tapes that only comprise one adhesive.

What is claimed is:

1. A cover tape comprising:
a first layer,
wherein the first layer has a first surface and a second surface opposite the first surface;
a first adhesive strip,
wherein the first adhesive strip is located on the second surface of the first layer;
wherein the first adhesive strip comprises a first pressure-sensitive adhesive;
wherein the first pressure-sensitive adhesive has a first glass transition temperature;
a second adhesive strip,
wherein the second adhesive strip is located on the second surface of the first layer;
wherein the second adhesive strip is adjacent to the first adhesive strip;
wherein the second adhesive strip comprises a second pressure-sensitive adhesive;
wherein the second pressure-sensitive adhesive has a second glass transition temperature;
wherein the second glass transition temperature of the second pressure-sensitive adhesive is different from the first glass transition temperature of the first pressure-sensitive adhesive.

2. The cover tape of claim 1, wherein the second glass transition temperature of the second pressure-sensitive adhesive is at least 10 °F greater than the first glass transition temperature of the first pressure-sensitive adhesive.

3. The cover tape of claim 1, wherein the first adhesive strip covers 1% to 50% of the second surface of the first layer; wherein the second adhesive strip covers 1% to 50% of the second surface of the first layer.

4. The cover tape of claim 1, wherein the first pressure-sensitive adhesive comprises:
1% to 80% by weight of a first polymer based on a total weight of the first pressure-sensitive adhesive;
1% to 50% by weight of a first tackifier based on the total weight of the first pressure-sensitive adhesive; and
1% to 50% by weight of a first plasticizer based on the total weight of the first pressure-sensitive adhesive.

5. The cover tape of claim 1, wherein the second pressure-sensitive adhesive comprises:
1% to 80% by weight of a second polymer based on a total weight of the second pressure-sensitive adhesive;
1% to 50% by weight of a second tackifier based on the total weight of the second pressure-sensitive adhesive; and
1% to 50% by weight of a second plasticizer based on the total weight of the second pressure-sensitive adhesive.

6. The cover tape of claim 1, further comprising:
a third adhesive strip,
wherein the third adhesive strip is located on the second surface of the first layer;
wherein the third adhesive strip is adjacent to the second adhesive strip opposite of the first adhesive strip;
wherein the third adhesive strip comprises a third pressure-sensitive adhesive.

7. The cover tape of claim 6, wherein the third pressure-sensitive adhesive is same as the first pressure-sensitive adhesive.

8. The cover tape of claim 6, further comprising:
a fourth adhesive strip,
wherein the fourth adhesive strip is located on the second surface of the first layer;
wherein the fourth adhesive strip is adjacent to the third adhesive strip opposite the second adhesive strip;
wherein the fourth adhesive strip comprises a fourth pressure-sensitive adhesive.

9. The cover tape of claim 8, wherein the third pressure-sensitive adhesive is same as the first pressure-sensitive adhesive and wherein the fourth pressure-sensitive adhesive is same as the second pressure-sensitive adhesive.

10. The cover tape of claim 1, wherein the second surface of the first layer has:
an adhesive surface portion,
wherein the first adhesive strip covers 1% to 50% of the adhesive surface portion of the second surface;
wherein the second adhesive strip covers 1% to 50% of the adhesive surface portion of the second surface;
wherein the first adhesive strip and the second adhesive strip, in combination, cover 2% to 80% of the second surface of the first layer;
a heat-weldable surface portion,
wherein the heat-weldable surface portion is adjacent to the adhesive surface portion;
wherein the heat-weldable surface portion does not comprise an adhesive.

11. A roofing system comprising:
at least one roofing substrate; and
a cover tape,
wherein the cover tape is located on the at least one roofing substrate,
wherein the cover tape comprises:
a first layer,
wherein the first layer has a first surface and a second surface opposite the first surface;
a first adhesive strip,
wherein the first adhesive strip is located on the second surface of the first layer;
wherein the first adhesive strip is adhered to the at least one roofing substrate;
wherein the first adhesive strip comprises a first pressure-sensitive adhesive;
wherein the first pressure-sensitive adhesive has a first glass transition temperature;
a second adhesive strip,
wherein the second adhesive strip is located on the second surface of the first layer;
wherein the second adhesive strip is adjacent to the first adhesive strip;
wherein the second adhesive strip is adhered to the at least one roofing substrate;
wherein the second adhesive strip comprises a second pressure-sensitive adhesive;
wherein the second pressure-sensitive adhesive has a second glass transition temperature;
wherein the second glass transition temperature of the second pressure-sensitive adhesive is different from the first glass transition temperature of the first pressure-sensitive adhesive.

12. The roofing system of claim 11, wherein the at least one roofing substrate comprises:
a membrane; and
a metal layer,
wherein the metal layer is located between the membrane and the cover tape, such that:
the first adhesive strip is adhered to the metal layer; and
the second adhesive strip is adhered to the membrane.

13. The roofing system of claim 11, wherein the second glass transition temperature of the second pressure sensitive adhesive is at least 10 °F greater than the first glass transition temperature of the first pressure sensitive adhesive.

14. The roofing system of claim 11, wherein the first adhesive strip covers 1% to 50% of the second surface of the first layer; wherein the second adhesive strip covers 1% to 50% of the second surface of the first layer.

15. The roofing system of claim 11, wherein the first pressure sensitive adhesive comprises:
1% to 80% by weight of a first polymer based on a total weight of the first pressure-sensitive adhesive;
1% to 50% by weight of a first tackifier based on the total weight of the first pressure-sensitive adhesive; and
1% to 50% by weight of a first plasticizer based on the total weight of the first pressure-sensitive adhesive.

16. The roofing system of claim 11, wherein the second pressure sensitive adhesive comprises:
1% to 80% by weight of a second polymer based on a total weight of the second pressure-sensitive adhesive;
1% to 50% by weight of a second tackifier based on the total weight of the second pressure-sensitive adhesive; and
1% to 50% by weight of a second plasticizer based on the total weight of the second pressure-sensitive adhesive.

17. The roofing system of claim 11, wherein the cover tape further comprises:
a third adhesive strip,
wherein the third adhesive strip is located on the second surface of the first layer;
wherein the third adhesive strip is adjacent to the second adhesive strip;
wherein the third adhesive strip comprises a third pressure sensitive adhesive.

18. The roofing system of claim 17, wherein the third pressure sensitive adhesive is same as the first pressure sensitive adhesive.

19. The roofing system of claim 17, wherein the cover tape further comprises:
a fourth adhesive strip,
wherein the fourth adhesive strip is located on the second surface of the first layer;
wherein the fourth adhesive strip is adjacent to the third adhesive strip;
wherein the fourth adhesive strip comprises a fourth pressure sensitive adhesive.

20. The roofing system of claim 11, wherein the second surface of the first layer has:
an adhesive surface portion,
wherein the first adhesive strip covers 1% to 50% of the adhesive surface portion of the second surface;
wherein the second adhesive strip covers 1% to 50% of the adhesive surface portion of the second surface;
wherein the first adhesive strip and the second adhesive strip, in combination, cover 2% to 80% of the second surface of the first layer;
a heat-weldable surface portion,
wherein the heat-weldable surface portion is located adjacent to the adhesive surface portion;
wherein the heat-weldable surface portion does not comprise an adhesive.
